(19) United States
(12) Patent Application Publication
(10) Pub. No.: US 2025/0271730 A1
(43) Pub. Date: Aug. 28, 2025

(54) LENS DRIVING DEVICE AND CAMERA MODULE

(71) Applicant: ALPS ALPINE CO., LTD., Tokyo (JP)

(72) Inventors: Junichiro YOKOTA, Miyagi (JP); Takuya KATO, Miyagi (JP); Takeshi MURAYAMA, Jiangsu (CN)

(21) Appl. No.: 19/057,081

(22) Filed: Feb. 19, 2025

(30) Foreign Application Priority Data
Feb. 22, 2024 (JP) 2024-025882

(51) Int. Cl. G03B 5/00; G02B 7/02; H04N 23/54; H04N 23/55

(52) U.S. Cl. CPC G03B 5/00; G02B 7/026; H04N 23/54; H04N 23/55; G03B 2205/0076

(57) ABSTRACT

A lens driving device includes a shape memory alloy wire including a first wire. The first wire has one end portion fixed to the first base-side metal member and the other end portion fixed to the second base-side metal member. An intermediate portion of the first wire positioned between the one end portion and the other end portion of the first wire is fixed to a first central fixing portion provided on the lens holding member. The first central fixing portion is arranged between the first base-side metal member and the second base-side metal member in a plan view along the optical axis direction, and the intermediate portion of the first wire is arranged at a position different from each of the one end portion and the other end portion of the first wire in the optical axis direction.

### CROSS-REFERENCE TO RELATED APPLICATIONS

Priority is claimed to Japanese Patent Application No. 2024-025882, filed Feb. 22, 2024, the entire content of which is incorporated herein by reference.

### BACKGROUND

### 1. Technical Field

The present disclosure relates to a lens driving device and a camera module.

### 2. Description of Related Art

Conventionally, a camera device (a lens driving device) configured to move a camera unit (a lens holding member) with respect to a support structure (a base member) by a shape memory alloy wire is known (see International Publication No. WO 2010/089529, hereinafter “Patent Document 1”). In this lens driving device, both of one end portion and the other end portion of the shape memory alloy wire are fixed to the lens holding member, and an intermediate portion between the one end portion and the other end portion is hooked on a hook provided on the base member.

### SUMMARY

According to the present disclosure, a lens driving device includes a base member, a lens holding member configured to hold a lens body, and a driver configured to include a shape memory alloy wire configured to move the lens holding member along an optical axis direction with respect to the base member. The shape memory alloy wire includes a first wire. The base member is provided with a first base-side metal member and a second base-side metal member which are arranged to be separated from each other in a first direction intersecting with the optical axis direction. The first wire has one end portion fixed to the first base-side metal member and the other end portion fixed to the second base-side metal member, and an intermediate portion of the first wire positioned between the one end portion and the other end portion of the first wire is fixed to a first central fixing portion provided on the lens holding member. The first central fixing portion is arranged between the first base-side metal member and the second base-side metal member in a plan view along the optical axis direction. The intermediate portion of the first wire is arranged at a position different from each of the one end portion and the other end portion of the first wire in the optical axis direction.

### BRIEF DESCRIPTION OF THE DRAWINGS

FIG. 1 is a perspective view of a camera module including a lens driving device according to an embodiment of the present disclosure;

FIG. 2 is an exploded perspective view of the lens driving device illustrated in FIG. 1;

FIG. 3 is a perspective view of a lens holding member, a lens-side metal member, a plate spring, a lens-side embedded member, and a position detecting magnet;

FIG. 4 is a perspective view of the lens holding member and the position detecting magnet;

FIG. 5 is a perspective view of a base member, a magnet, a base-side metal member, a supported-side metal member, a plate spring, a flexible metal member, and a base-side embedded member;

FIG. 6 is a perspective view of the base member, the magnet, the supported-side metal member, the flexible metal member, the supporting-side embedded member, and the base-side embedded member;

FIG. 7 is a perspective view of a supporting-side metal member, a flexible metal member, a support member, a supporting-side embedded member, and a magnetic member;

FIG. 8 is a perspective view of the supporting-side metal member, the support member, the supporting-side embedded member, and the magnetic member;

FIG. 9 is a diagram illustrating an example of the configuration of a base-side metal member, a lens-side metal member, and a shape memory alloy wire;

FIG. 10 is a perspective view of the base-side metal member, the lens-side metal member, the supporting-side metal member, the supported-side metal member, the flexible metal member, the supporting-side embedded member, the base-side embedded member, and the shape memory alloy wire;

FIG. 11 is a perspective view of the base-side metal member, the lens-side metal member, the flexible metal member, the supporting-side embedded member, the base-side embedded member, and the shape memory alloy wire;

FIG. 12 is a perspective view of the supporting-side metal member, the supported-side metal member, the flexible metal member, the supporting-side embedded member, the base-side embedded member, and the shape memory alloy wire;

FIG. 13 is a top view of a first driver;

FIG. 14 is a bottom view and a cross-sectional view of the base member, the support member, and a second driver; and

FIG. 15 is a perspective view of another configuration example of the lens driving device according to the embodiment of the present disclosure.

### DETAILED DESCRIPTION

In the above-described lens driving device, when the length of the shape memory alloy wire changes with energization of the shape memory alloy wire, undesirable situations, for example, generation of abrasion powder caused by the intermediate portion of the shape memory alloy wire sliding on the hook, or detachment of the intermediate portion of the shape memory alloy wire from the holding element in the case where a strong impact is applied to the lens driving device due to dropping or the like, can potentially occur.

Therefore, it is desired to provide a lens driving device capable of suppressing an occurrence of such undesirable situations related to the holding of the shape memory alloy wire.

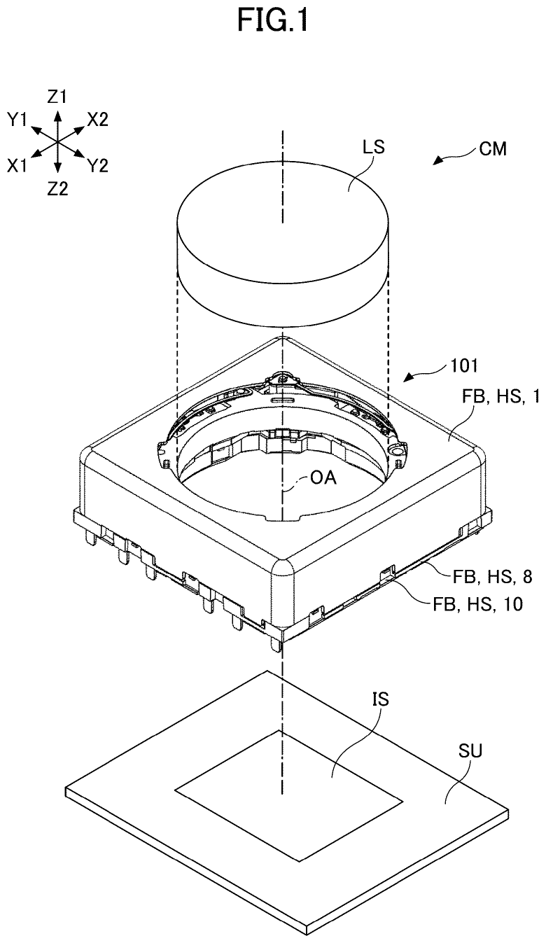

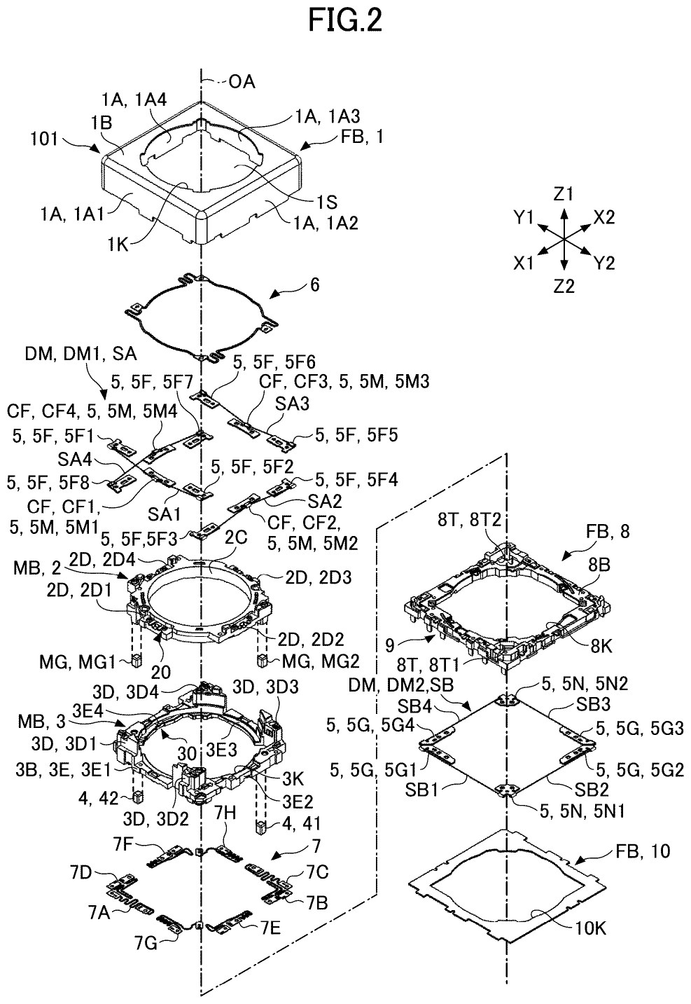

Hereinafter, a lens holder driving device 101 according to an embodiment of the present invention will be described with reference to the drawings. FIG. 1 is a perspective view of a camera module CM including a lens driving device 101. FIG. 2 is an exploded perspective view of the lens holder driving device 101.

In FIGS. 1 and 2, X1 represents one direction of the X-axis included in the three dimensional orthogonal coordinate system, and X2 represents the other direction of the X-axis. Y1 represents one direction of the Y-axis included in the three-dimensional orthogonal coordinate system, and Y2 represents the other direction of the Y-axis. Similarly, Z1 represents one direction of the Z-axis included in the three-dimensional orthogonal coordinate system, and Z2 represents the other direction of the Z-axis. In FIGS. 1 and 2, the X1 side of the lens driving device 101 corresponds to the front side (front surface side) of the lens driving device 101, and the X2 side of the lens driving device 101 corresponds to the rear side (rear surface side) of the lens driving device 101. The Y1 side of the lens driving device 101 corresponds to the left side of the lens driving device 101, and the Y2 side of the lens driving device 101 corresponds to the right side of the lens driving device 101. The Z1 side of the lens driving device 101 corresponds to the upper side (subject side) of the lens driving device 101, and the Z2 side of the lens driving device 101 corresponds to the lower side (image sensor side) of the lens driving device 101. The same applies to the other drawings.

As illustrated in FIG. 1, the camera module CM includes a substrate SU, a lens driving device 101, a lens body LS attached to the lens driving device 101, and an image sensor IS mounted on the substrate SU so as to face the lens body LS. The camera module CM is connected to a control device (not illustrated) configured by a microcomputer or the like including a CPU, a memory, and the like. In the illustrated example, the control device is arranged outside the camera module CM, but may be arranged inside the camera module CM. The lens driving device 101 having a substantially rectangular parallelepiped outer shape is attached on a substrate SU on which an image sensor IS is mounted, as illustrated in FIG. 1.

Specifically, as illustrated in FIGS. 1 and 2, the lens driving device 101 includes a cover member 1, a support member 8, and a magnetic member 10, which are parts of the fixed-side member FB. The cover member 1 is configured to function as a part of a housing HS of the lens driving device 101. In the illustrated example, the cover member 1 is formed of a nonmagnetic metal. However, the cover member 1 may be formed of a magnetic metal.

Specifically, as illustrated in FIG. 2, the cover member 1 has an outer shape of a bottomless box defining the storage portion 1S. In other words, the cover member 1 includes a rectangular cylindrical outer peripheral wall portion 1A and a rectangular annular and flat top plate portion 1B provided to be continuous with the upper end (end on the Z1 side) of the outer peripheral wall portion 1A. A substantially circular opening 1K is formed at the center of the top plate portion 1B. The outer wall portion 1A includes a first side plate portion 1A1 through a fourth side plate portion 1A4. The first side plate portion 1A1 and the third side plate portion 1A3 face each other, and the second side plate portion 1A2 and the fourth side plate portion 1A4 face each other. The first side plate portion 1A1 and the third side plate portion 1A3 extend perpendicularly to the second side plate portion 1A2 and the fourth side plate portion 1A4. The cover member 1, the support member 8, and the magnetic member 10 are bonded to each other with an adhesive as illustrated in FIG. 1, and constitute the housing HS.

As illustrated in FIG. 2, a lens holding member 2, a base member 3, a magnet 4, a metal member 5, a plate spring 6, a flexible metal member 7, the support member 8, a supporting-side embedded member 9, a lens-side embedded member 20, a base-side embedded member 30, a position detecting magnet MG, a shape memory alloy wire SA, a shape memory alloy wire SB, and the like are accommodated between the cover member 1 and the magnetic member 10.

The lens holding member 2 is a member capable of holding the lens body LS (see FIG. 1), and is a part of a movable-side member MB. The lens body LS is, for example, a cylindrical lens barrel including at least one lens, and is configured such that the central axis thereof is along an optical axis OA.

In the illustrated example, the lens holding member 2 is formed by injection molding of a synthetic resin such as a liquid crystal polymer (LCP). Specifically, as illustrated in FIG. 2, the lens holding member 2 includes a cylindrical portion 2C formed so as to extend along the optical axis OA, and a pedestal portion 2D formed so as to protrude from the cylindrical portion 2C on the outer side in the radial direction of a circle centered on the optical axis OA. The pedestal portion 2D includes a first pedestal portion 2D1 through a fourth pedestal portion 2D4. The first pedestal portion 2D1 and the third pedestal portion 2D3 are arranged so as to extend in opposite directions to each other in a radial direction (the X-axis direction) with the optical axis OA interposed therebetween, and the second pedestal portion 2D2 and the fourth pedestal portion 2D4 are arranged so as to extend in opposite directions to each other in the radial direction (the Y-axis direction) with the optical axis OA interposed therebetween. A part of the plate spring 6 is placed on each of the second pedestal portion 2D2 and the fourth pedestal portion 2D4. In addition, the lens-side metal member 5M is placed on each of the first pedestal portion 2D1 through the fourth pedestal portion 2D4.

The driver DM is configured to be able to move the movable-side member MB with respect to the fixed-side member FB. In the illustrated example, the driver DM includes a shape memory alloy wire, which is an example of a shape memory actuator. Specifically, the driver DM includes a first driver DM1 for moving the lens holding member 2 with respect to the base member 3 and a second driver DM2 for moving the base member 3 with respect to the support member 8. The first driver DM1 includes a shape memory alloy wire SA, and the second driver DM2 includes a shape memory alloy wire SB. The shape memory alloy wire SA includes first to fourth wires SA1 to SA4, and the shape memory alloy wire SB includes first to fourth wires SB1 to SB4.

The shape memory alloy wire is configured to increase in temperature when a current flows therethrough and contract in accordance with an increase in temperature. Specifically, as illustrated in FIG. 2, the shape memory alloy wire SA is stretched in a V shape or an inverted V shape along the inner surface of the outer peripheral wall portion 1A of the cover member 1 when a current is supplied, and is configured to be able to move the lens holding member 2 with respect to the base member 3. In each of the first wire SA1 through the fourth wire SA4, one end portion and the other end portion are fixed to the base-side metal member 5F by crimping, welding, or the like, and an intermediate portion positioned between the one end portion and the other end portion is fixed to the lens-side metal member 5M by crimping, welding, or the like. As illustrated in FIG. 2, the shape memory alloy wire SB is configured to be stretched linearly along each side of the support member 8 when a current is supplied, and to be able to move the base member 3 with respect to the support member 8. Each of the first wire SB1 through the fourth wire SB4 has one end portion fixed to the supported-side metal member 5N by crimping, welding, or the like, and the other end portion fixed to the supporting-side metal member 5G by crimping, welding, or the like.

In the illustrated example, the first wire SA1 and the second wire SA2, the second wire SA2 and the third wire SA3, the third wire SA3 and the fourth wire SA4, the fourth wire SA4 and the first wire SA1, the first wire SB1 and the second wire SB2, the second wire SB2 and the third wire SB3, the third wire SB3 and the fourth wire SB4, and the fourth wire SB4 and the first wire SB1 are arranged to cross (to be substantially orthogonal to) each other when viewed along an optical axis direction (the Z-axis direction). The fact that two shape memory alloy wires intersect means that a straight line passing through one end and the other end of one shape memory alloy wire intersects a straight line passing through one end and the other end of the other shape memory alloy wire.

The first driver DM1 can move the lens holding member 2 up and down along the optical axis direction (the Z-axis direction), which is a direction parallel to the optical axis OA, by using contraction of the shape memory alloy wire SA. The shape memory alloy wire SA is configured in such a manner that when one or more of the first to fourth wires SA1 to SA4 contract, the lens holding member 2 moves, and the other one or more wires are extended by the movement. Similarly, the second driver DM2 can move the base member 3 (including the lens holding member 2) to the left and right along a first direction (the Y-axis direction) perpendicular to the optical axis OA by using the contraction of the shape memory alloy wire SB, and can move the base member 3 (including the lens holding member 2) to the front and rear along the second direction (the X-axis direction) perpendicular to the optical axis OA and the first direction by using contraction of the shape memory alloy wire SB. The shape memory alloy wire SB is configured in such a manner that when one or more of the first to fourth wires SB1 to SB4 contract, the base member 3 moves, and the other one or more wires are extended by the movement.

The base member 3 is a member which is movable in each of the X-axis direction and the Y-axis direction with respect to the fixed-side member FB (the support member 8), and is a part of a movable-side member MB. In the illustrated example, the base member 3 is formed by injection molding of a synthetic resin such as a liquid crystal polymer (LCP). Specifically, the base member 3 has a substantially rectangular outer shape in a plan view (top view), and has a substantially circular opening 3K at the center. Specifically, the base member 3 includes a main body portion 3B having a rectangular annular shape formed to surround the opening 3K, and a pedestal portion 3D, which is a portion protruding upward from the main body portion 3B. The pedestal portion 3D includes a first pedestal portion 3D1 through a fourth pedestal portion 3D4. The first pedestal portion 3D1 and the third pedestal portion 3D3 are arranged so as to face each other in the radial direction with the optical axis OA interposed therebetween, and the second pedestal portion 3D2 and the fourth pedestal portion 3D4 are arranged so as to face each other in the radial direction with the optical axis OA interposed therebetween. More specifically, the main body portion 3B is configured to include four side portions 3E (the first side portion 3E1 through the fourth side portion 3E4); the first pedestal portion 3D1 is provided between the fourth side portion 3E4 and the first side portion 3E1; the second pedestal portion 3D2 is provided between the first side portion 3E1 and the second side portion 3E2; the third pedestal portion 3D3 is provided between the second side portion 3E2 and the third side portion 3E3; and the fourth pedestal portion 3D4 is provided between the third side portion 3E3 and the fourth side portion 3E4. A part of the plate spring 6 is placed on each of the second pedestal portion 3D2 and the fourth pedestal portion 3D4. In addition, the base-side metal member 5F is placed on each of the first pedestal portion 3D1 through the fourth pedestal portion 3D4.

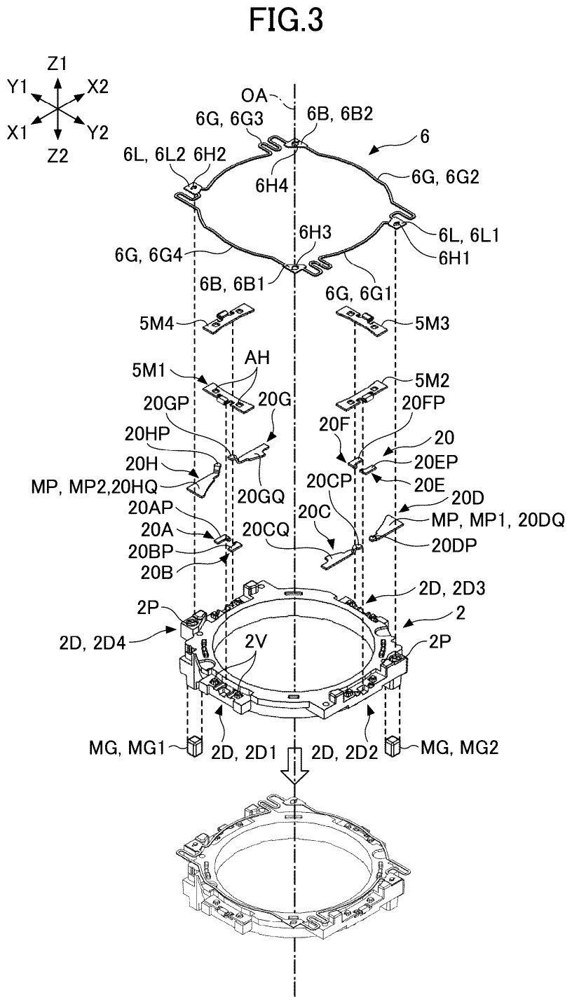

The magnet 4 is a member for suppressing the base member 3 from being separated from each of the lens holding member 2 and the support member 8 in conjunction with a magnetic member fixed to each of the lens holding member 2 and the support member 8. Specifically, the magnet 4 is attached to the base member 3 so as to be magnetically attracted to the lens-side magnetic member MP embedded in the lens holding member 2 as illustrated in FIG. 3 and so as to be magnetically attracted to the magnetic member 10 adhered and fixed to the support member 8 as illustrated in FIG. 1. In the illustrated example, the magnet 4 is a permanent magnet polarized in two poles along the Z-axis direction, and includes a first magnet 41 and a second magnet 42.

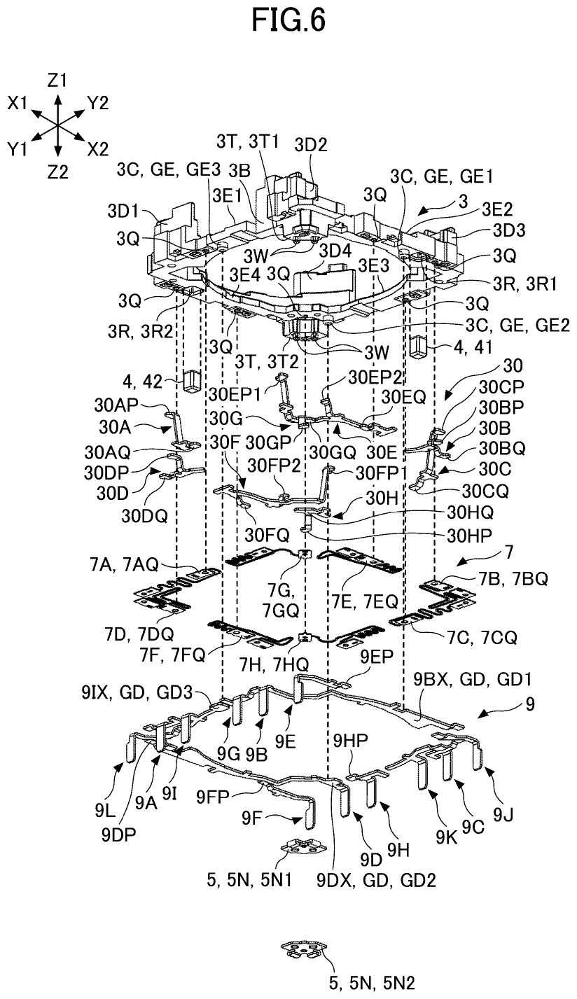

The metal member 5 is configured in such a manner that a part of the shape memory alloy wire is fixed thereto. In the illustrated example, the metal member 5 is formed of a nonmagnetic metal, and includes a base-side metal member 5F, a lens-side metal member 5M, a supporting-side metal member 5G, and a supported-side metal member 5N. The base-side metal member 5F is configured to be fixed to the pedestal portion 3D of the base member 3. The lens-side metal member 5M is configured to be fixed to the pedestal portion 2D of the lens holding member 2. The supporting-side metal member 5G is configured to be fixed to the lower surface of the support member 8. The supported-side metal member 5N is configured to be fixed to a protruding portion 3T (see FIG. 6) that protrudes downward from the lower surface of the base member 3. The base-side metal member 5F may be embedded in the pedestal portion 3D of the base member 3, and the lens-side metal member 5M may be embedded in the pedestal portion 2D of the lens holding member 2. The supporting-side metal member 5G may be embedded in the lower surface of the support member 8, and the supported-side metal member 5N may be embedded in the protruding portion 3T of the base member 3.

More specifically, the base-side metal member 5F includes a first base-side metal member 5F1 through an eighth base-side metal member 5F8, and the lens-side metal member 5M includes a first lens-side metal member 5M1 through a fourth lens-side metal member 5M4. The supporting-side metal member 5G includes a first supporting-side metal member 5G1 through a fourth supporting-side metal member 5G4, and the supported-side metal member 5N includes a first supported-side metal member 5N1 and a second supported-side metal member 5N2.

The plate spring 6 is configured to be able to support the lens holding member 2 so as to be movable in a direction parallel to the optical axis OA with respect to the base member 3. In the present embodiment, the plate spring 6 is made of a metal plate mainly made of, for example, a copper alloy, a titanium-copper-based alloy (titanium-copper), or a copper-nickel alloy (nickel-tin-copper). In the illustrated example, the plate spring 6 couples the lens holding member 2 and the base member 3 in such a manner that the center of the lens holding member 2 and the center of the base member 3 coincide with each other in a neutral state of the lens driving device 101. In other words, the plate spring 6 is configured to be able to center the lens holding member 2 with respect to the base member 3 in the XY plane. Specifically, the plate spring 6 is configured to connect the pedestal portion 2D (the second pedestal portion 2D2 and the fourth pedestal portion 2D4) formed on the lens holding member 2 and the pedestal portion 3D (the second pedestal portion 3D2 and the fourth pedestal portion 3D4) formed on the base member 3. The neutral state of the lens driving device 101 is, for example, a state in which the first to fourth wires SA1 through SA4 and the first to fourth wires SB1 through SB4 are supplied with a current, and the movable-side member MB (the lens holding member 2 and the base member 3) is positioned in the middle of the movable range in each of the three axes (the X-axis, the Y-axis, and the Z-axis) orthogonal to each other, that is, a state in which the movable-side member MB (the lens holding member 2 and the base member 3) is in the neutral position. Typically, in the neutral state of the lens driving device 101, the lens holding member 2 is positioned at the center of the movable range in each of the three axes, and the base member 3 is positioned at the center of the movable range in each of the two axes (the X axis and the Y axis).

The flexible metal member 7 is a member for supplying a current to each of the shape memory alloy wire SA and the shape memory alloy wire SB. Specifically, the flexible metal member 7 includes a fixed bonding portion fixed to the support member 8, a movable bonding portion fixed to the base member 3, and an elastic arm portion that is elastically deformable and connects the fixed bonding portion and the movable bonding portion. In the illustrated example, the flexible metal member 7 includes a first flexible metal member 7A through an eighth flexible metal member 7H.

The support member 8 is a member for supporting the movable-side member MB and is a part of the fixed-side member FB. In the illustrated example, the support member 8 is formed by injection molding of a synthetic resin such as a liquid crystal polymer (LCP). Specifically, the support member 8 has a substantially rectangular outer shape in a plan view (top view), and has a substantially circular opening 8K at the center. The support member 8 has a rectangular annular base portion 8B formed to surround the opening 8K.

The support member 8 has a through portion 8T (through portion 8T through which at least a part of the protruding portion 3T is inserted) in which the protruding portion 3T (see FIG. 6) of the base member 3 is arranged. In the illustrated example, the support member 8 includes a first through portion 8T1 in which a first protruding portion 3T1 is arranged and a second through portion 8T2 in which a second protruding portion 3T2 is arranged. This configuration provides an effect that the lens driving device 101 including the second driver DM2 (the shape memory alloy wire SB) arranged on the lower surface side of the support member 8 can be realized with a simple structure. In particular, this configuration provides an effect that the assembly of the supported-side metal member 5N of the second driver DM2 to the base member 3 can be realized by a simple structure.

The supporting-side embedded member 9 is a metal member embedded in the support member 8. Specifically, the supporting-side embedded member 9 includes a terminal used for electrical connection to the outside and a bonding portion exposed on the surface of the support member 8 and used for bonding to another metal member. In the illustrated example, the supporting-side embedded member 9 includes a first supporting-side embedded member 9A through a twelfth supporting-side embedded member 9L as illustrated in FIG. 6.

The lens-side embedded member 20 is a metal member embedded in the lens holding member 2. Specifically, the lens-side embedded member 20 has a bonding portion which is exposed on the surface of the lens holding member 2 and is used for bonding to another metal member. In the illustrated example, the lens-side embedded member 20 includes a first lens-side embedded member 20A through an eighth lens-side embedded member 20H as illustrated in FIG. 3. The fourth lens-side embedded member 20D and the eighth lens-side embedded member 20H function as a lens-side magnetic member MP that operates together with the magnet 4.

The lens-side magnetic member MP (see FIG. 3) is a member for positioning the lens holding member 2 at a predetermined position with respect to the base member 3. Specifically, the lens-side magnetic member MP is embedded in the lens holding member 2 so that the lens holding member 2 (the lens-side magnetic member MP) is attracted to the base member 3 (the magnet 4) by an attraction force acting between the magnet 4 fixed to the base member 3 and the lens-side magnetic member MP, and the lens holding member 2 is centered in the XY plane. In the illustrated example, the lens-side magnetic member MP is a metal plate formed of a magnetic metal. However, the lens-side magnetic member MP may be a magnet, and may be formed of a magnetic resin material or the like as long as a magnetic attraction force can be generated between the lens-side magnetic member MP and the magnet 4.

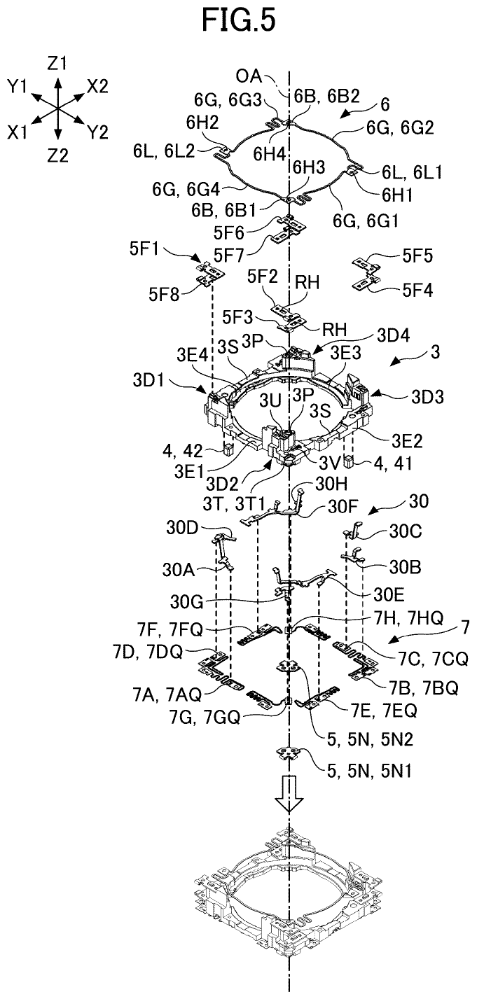

The base-side embedded member 30 is a metal member embedded in base member 3. Specifically, the base-side embedded member 30 includes a wire-side bonding portion exposed on the surface of the base member 3 and used for bonding to the metal member 5, and a lower-side bonding portion exposed on the lower surface of the base member 3 and used for bonding to the flexible metal member 7. In the illustrated example, the base-side embedded member 30 includes a first base-side embedded member 30A through an eighth base-side embedded member 30H as illustrated in FIG. 5.

The position detection magnet MG is a member for detecting the position of the lens holding member 2 in conjunction with a magnetic sensor (not illustrated) mounted on the substrate SU. Specifically, the position detection magnet MG is provided on the lens holding member 2 so as to face the magnetic sensor mounted on the substrate SU. In the illustrated example, the position detecting magnet MG is a permanent magnet magnetized in two poles along the Z-axis direction, and includes first position detecting magnet MG1 and the second position detecting magnet MG2.

The magnetic member 10 is a member for suppressing the base member 3 from being separated from the support member 8 in conjunction with the magnet 4 fixed to the base member 3. In the illustrated example, the magnetic member 10 is a rectangular annular and flat metal plate formed of a magnetic metal. However, the magnetic member 10 may be a magnet, and may be formed of a magnetic resin material or the like as long as a magnetic attraction force can be generated between the magnetic member 10 and the magnet 4. The magnetic member 10 may be embedded in the support member 8 by insert molding or the like. Specifically, the magnetic member 10 has a substantially rectangular outer shape in a plan view (top view), and has a substantially circular opening 10K at the center.

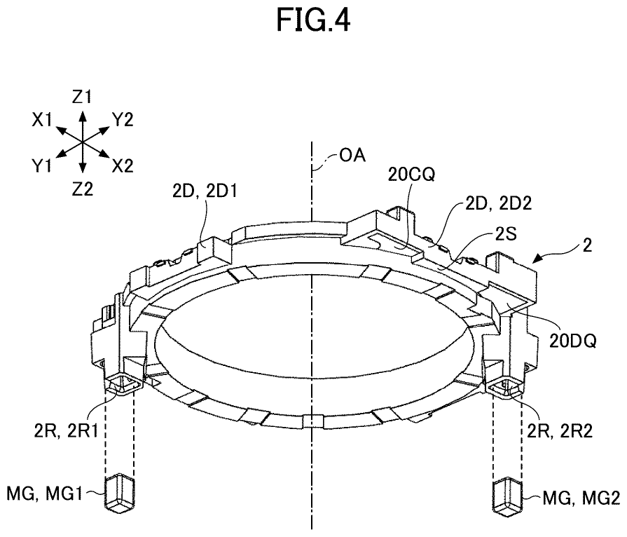

Next, a positional relationship between the lens holding member 2 and a member attached to the lens holding member 2 will be described with reference to FIGS. 3 and 4. FIG. 3 is a top perspective view of the lens holding member 2, the lens-side metal member 5M, the plate spring 6, the lens-side embedded member 20, and the position detecting magnet MG. Specifically, the top diagram of FIG. 3 (the diagram above the block arrow) is an exploded perspective view, and the bottom diagram of FIG. 3 (the diagram below the block arrow) is an assembled perspective view. FIG. 4 is a bottom perspective view of the lens holding member 2 and the position detecting magnet MG.

In the example illustrated in the top diagram of FIG. 3, the first lens-side metal member 5M1 is fixed to the upper surface of the first pedestal portion 2D1. Specifically, the first lens-side metal member 5M1 is fixed to the first pedestal portion 2D1 with an adhesive in a state where two rectangular protrusions 2V formed on the upper surface of the first pedestal portion 2D1 and protruding to the upper side (the Z1 side) and two rectangular holes AH formed in the first lens-side metal member 5M1 are engaged with each other. The adhesive is, for example, a photo-curable adhesive. The photo-curable adhesive is, for example, an ultraviolet curable adhesive or a visible light curable adhesive. Similarly, the second lens-side metal member 5M2 is fixed to the upper surface of the second pedestal portion 2D2, the third lens-side metal member 5M3 is fixed to the upper surface of the third pedestal portion 2D3, and the fourth lens-side metal member 5M4 is fixed to the upper surface of the fourth pedestal portion 2D4.

The plate spring 6 includes a base-side portion 6B fixed to the pedestal portion 3D (see FIG. 2) of the base member 3, a lens-side portion 6L fixed to the pedestal portion 2D of the lens holding member 2, and an elastic portion 6G connecting the base-side portion 6B and the lens-side portion 6L. Specifically, the base-side portion 6B includes a first base-side portion 6B1 and a second base-side portion 6B2, the lens-side portion 6L includes a first lens-side portion 6L1 and a second lens-side portion 6L2, and the elastic portion 6G includes a first elastic portion 6G1 through a fourth elastic portion 6G4. The first elastic portion 6G1 connects the first lens-side portion 6L1 and the first base-side portion 6B1; the second elastic portion 6G2 connects the first lens-side portion 6L1 and the second base-side portion 6B2; the third elastic portion 6G3 connects the second lens-side portion 6L2 and the second base-side portion 6B2; and the fourth elastic portion 6G4 connects the second lens-side portion 6L2 and the first base-side portion 6B1.

The first lens-side portion 6L1 is provided with a first through-hole 6H1 through which a round projection 2P formed on the upper surface of the second pedestal portion 2D2 and projecting upward is inserted. The second lens-side portion 6L2 is provided with a second through hole 6H2 through which a round projection 2P formed on the upper surface of the fourth pedestal portion 2D4 and projecting upward is inserted. In the illustrated example, the plate spring 6 and the projection 2P are bonded to each other with an adhesive. However, the plate spring 6 and the projection 2P may be bonded by performing thermal caulking or cold caulking on the projection 2P.

Similarly, the first base-side portion 6B1 is provided with a third through hole 6H3 through which a round projection 3P (see FIG. 5) formed on the upper surface of the second pedestal portion 3D2 (see FIG. 5) and projecting upward is inserted. The second base-side portion 6B2 is provided with a fourth through hole 6H4 through which a round projection 3P (see FIG. 5) formed on the upper surface of the fourth pedestal portion 3D4 and projecting upward is inserted. In the illustrated example, the plate spring 6 and the projection 3P are bonded to each other with an adhesive. However, the plate spring 6 and the projection 3P may be bonded by performing thermal caulking or cold caulking on the projection 3P.

As illustrated in FIG. 3, the plate spring 6 is configured to be two fold rotationally symmetric with respect to the optical axis OA. Therefore, the plate spring 6 can support the lens holding member 2 in the air in a well-balanced manner. Further, the plate spring 6 does not adversely affect the balance of the movable-side member MB (the lens holding member 2) supported by the four shape memory alloy wires SA (the first wire SA1 through the fourth wire SA4).

The first lens-side embedded member 20A has a first bonding portion 20AP exposed on the upper surface of the first pedestal portion 2D1, and the second lens side embedded member 20B has a second bonding portion 20BP exposed on the upper surface of the first pedestal portion 2D1. The first bonding portion 20AP and the second bonding portion 20BP are welded to the first lens-side metal member 5M1. The first lens-side metal member 5M1 may be bonded to each of the first bonding portion 20AP and the second bonding portion 20BP by an adhesive, solder, or the like. The same applies to: the bonding between the third bonding portion 20CP of the third lens-side embedded member 20C and the fourth bonding portion 20DP of the fourth lens-side embedded member 20D exposed on the upper surface of the second pedestal portion 2D2 to the second lens-side metal member 5M2; the bonding between the fifth bonding portion 20EP of the fifth lens-side embedded member 20E and the sixth bonding portion 20FP of the sixth lens-side embedded member 20F exposed on the upper surface of the third pedestal portion 2D3 to the third lens-side metal member 5M3; and the bonding between the seventh bonding portion 20GP of the seventh lens-side embedded member 20G and the eighth bonding portion 20HP of the eighth lens-side embedded member 20H exposed on the upper surface of the fourth pedestal portion 2D4 to the fourth lens-side metal member 5M4.

As illustrated in FIG. 4, the third lens-side embedded member 20C has a third exposed portion 20CQ exposed to the lower surface of the second pedestal portion 2D2, and the fourth lens-side embedded member 20D has a fourth exposed portion 20DQ exposed to the lower surface of the second pedestal portion 2D2. Similarly, although not visible in FIG. 4, the seventh lens-side embedded member 20G has a seventh exposed portion 20GQ exposed on the lower surface of the fourth pedestal portion 2D4, and the eighth lens-side embedded member 20H has an eighth exposed portion 20HQ exposed on the lower surface of the fourth pedestal portion 2D4.

As illustrated in FIG. 4, an accommodating portion 2R that opens downward (in the Z2 direction) is formed in the lower surface of the lens holding member 2. The position detecting magnet MG is accommodated in the accommodating portion 2R and fixed with an adhesive. Specifically, the accommodating portion 2R includes a first accommodating portion 2R1 and a second accommodating portion 2R2. The first accommodating portion 2R1 accommodates the first position detecting magnet MG1, and the second accommodating portion 2R2 accommodates the second position detecting magnet MG2.

Next, a positional relationship between the base member 3 and a member that is in contact with the base member 3 will be described with reference to FIGS. 5 and 6. FIG. 5 is a top perspective view of the base member 3, the magnet 4, the base-side metal member 5F, the supported-side metal member 5N, the plate spring 6, the flexible metal member 7, and the base-side embedded member 30.

Specifically, the top diagram of FIG. 5 (the diagram above the block arrow) is an exploded perspective view, and the bottom diagram of FIG. 5 (the diagram below the block arrow) is an assembled perspective view. FIG. 6 is a bottom perspective view of the base member 3, the magnet 4, the supported-side metal member 5N, the flexible metal member 7, the supporting-side embedded member 9, and the base-side embedded member 30.

As illustrated in FIG. 6, an accommodating portion 3R that opens downward (in the 22 direction) is formed in the lower surface of the base member 3. The magnet 4 is accommodated in the accommodating portion 3R and fixed with an adhesive. Specifically, the accommodating portion 3R includes a first accommodating portion 3R1 and a second accommodating portion 3R2. The first accommodating portion 3R1 accommodates the first magnet 41, and the second accommodating portion 3R2 accommodates the second magnet 42.

In the example illustrated in the top diagram of FIG. 5, the second base-side metal member 5F2 is fixed to the upper placement surface of the second pedestal portion 3D2 of the base member 3, and the third base-side metal member 5F3 is fixed to the lower placement surface of the second pedestal portion 3D2 of the base member 3. Specifically, the second base-side metal member 5F2 is fixed to the upper placement surface of the second pedestal portion 3D2 with an adhesive in a state where a square projection 3U formed on the upper placement surface of the second pedestal portion 3D2 and projecting to the upper side (the Z1 side) and a rectangular hole RH formed in the second base-side metal member 5F2 are engaged with each other. The third base-side metal member 5F3 is fixed to the lower side placing surface of the second pedestal portion 3D2 with an adhesive in a state where the rectangular projection 3V which is formed on the lower side placing surface of the second pedestal portion 3D2 and protrudes to the upper side (the Z1 side) and the rectangular hole RH which is formed in the third base-side metal member 5F3 are engaged with each other. Similarly, the first base-side metal member 5F1 is fixed to the upper placement surface of the first pedestal portion 3D1 of the base member 3; the fourth base-side metal member 5F4 is fixed to the lower placement surface of the third pedestal portion 3D3 of the base member 3; the fifth base-side metal member 5F5 is fixed to the upper placement surface of the third pedestal portion 3D3 of the base member 3; the sixth base-side metal member 5F6 is fixed to the upper placement surface of the fourth pedestal portion 3D4 of the base member 3; the seventh base-side metal member 5F7 is fixed to the lower placement surface of the fourth pedestal portion 3D4 of the base member 3; and the eighth base-side metal member 5F8 is fixed to the lower placement surface of the first pedestal portion 3D1 of the base member 3. Thus, each of the first pedestal portion 3D1 through the fourth pedestal portion 3D4 has the upper placement surface and the lower placement surface. The upper placement surface and the lower placement surface are surfaces perpendicular to the optical axis OA.

The first flexible metal member 7A through the eighth flexible metal member 7H respectively include a first movable bonding portion 7AQ through an eighth movable bonding portion 7HQ. As illustrated in FIG. 6, each of the first movable bonding portion 7AQ through the eighth movable bonding portion 7HQ is formed with a through hole through which a round projection 30 formed on the lower surface of the base member 3 and projecting downward is inserted. In the illustrated example, the flexible metal member 7 and the base member 3 are bonded to each other with an adhesive. However, the flexible metal member 7 and the base member 3 may be bonded by performing thermal caulking or cold caulking on the projection 30.

As illustrated in FIG. 6, a protruding portion 3T protruding downward is formed on the lower surface of the base member 3. The protruding portion 3T includes a first protruding portion 3T1 protruding downward from the second pedestal portion 3D2 and a second protruding portion 3T2 protruding downward from the fourth pedestal portion 3D4. The first supported-side metal member 5N1 is formed with two through holes through which two projections 3W formed on the lower surface of the first protruding portion 3T1 and protruding downward are inserted. The first supported-side metal member 5N1 and the projection 3W are bonded to each other with an adhesive. However, the bonding between the first supported-side metal member 5N1 and the projection 3W may be realized by performing thermal caulking or cold caulking on the projection 3W. The same applies to the bonding between the second supported-side metal member 5N2 and the projection 3W formed on the second protruding portion 3T2.

The first base-side embedded member 30A includes a first wire-side bonding portion 30AP exposed on the upper placement surface of the first pedestal portion 3D1 of the base member 3 and a first base-side bonding portion 30AQ exposed on the lower surface of the first side portion 3E1 of the base member 3. The second base-side embedded member 30B includes a second wire-side bonding portion 30BP exposed on the lower placement surface of the third pedestal portion 3D3 of the base member 3 and a second base-side bonding portion 30BQ exposed on the lower surface of the second side portion 3E2 of the base member 3. The third base-side embedded member 30C includes a third wire-side bonding portion 30CP exposed on the upper placement surface of the third pedestal portion 3D3 of the base member 3 and a third base-side bonding portion 30CQ exposed on the lower surface of the third side portion 3E3 of the base member 3. The fourth base-side embedded member 30D includes a fourth wire-side bonding portion 30DP exposed on the lower placement surface of the first pedestal portion 3D1 of the base member 3 and a fourth base-side bonding portion 30DQ exposed on the lower surface of the fourth side portion 3E4 of the base member 3. The fifth base-side embedded member 30E includes a fifth upper wire-side bonding portion 30EP1 exposed on the upper placement surface of the second pedestal portion 3D2 of the base member 3, a fifth lower wire-side bonding portion 30EP2 exposed on the lower placement surface of the second pedestal portion 3D2 of the base member 3, and a fifth base-side bonding portion 30EQ exposed on the lower surface of the second side portion 3E2 of the base member 3. The sixth base-side embedded member 30F includes a sixth upper wire-side bonding portion 30FP1 exposed on the upper placement surface of the fourth pedestal portion 3D4 of the base member 3, a sixth lower wire-side bonding portion 30FP2 exposed on the lower placement surface of the fourth pedestal portion 3D4 of the base member 3, and a sixth base-side bonding portion 30FQ exposed on the lower surface of the fourth side portion 3E4 of the base member 3. The seventh base-side embedded member 30G includes a seventh wire-side bonding portion 30GP exposed on the lower surface of the first protruding portion 3T1 of the base member 3 and a seventh base-side bonding portion 30GQ exposed on the lower surface of the second pedestal portion 3D2 of the base member 3. The eighth base-side embedded member 30H includes an eighth wire-side bonding portion 30HP exposed on the lower surface of the second protruding portion 3T2 of the base member 3 and an eighth base-side bonding portion 30HQ exposed on the lower surface of the fourth pedestal portion 3D4 of the base member 3.

The first wire-side bonding portion 30AP and the first base-side metal member 5F1 are welded together. The first wire-side bonding portion 30AP and the first base-side metal member 5F1 may be bonded to each other with an adhesive, solder, or the like. The same applies to the bonding between the second wire-side bonding portion 30BP and the fourth base-side metal member 5F4; the bonding between the third wire-side bonding portion 30CP and the fifth base-side metal member 5F5; the bonding between the fourth wire-side bonding portion 30DP and the eighth base-side metal member 5F8; the bonding between the fifth upper wire-side bonding portion 30EP1 and the second base-side metal member 5F2; the bonding between the fifth lower wire-side bonding portion 30EP2 and the third base-side metal member 5F3; the bonding between the sixth upper wire-side bonding portion 30FP1 and the sixth base-side metal member 5F6; the bonding between the sixth lower wire-side bonding portion 30FP2 and the seventh base-side metal member 5F7; the bonding between the seventh wire-side bonding portion 30GP and the first supported-side metal member 5N1; and the bonding between the eighth wire-side bonding portion 30HP and the second supported-side metal member 5N2.

In addition, each of the first movable bonding portion 7AQ through the eighth movable bonding portion 7HQ is formed with a round-cornered quadrangular through hole used at the time of welding. The first movable bonding portion 7AQ and the first base-side bonding portion 30AQ of the first base-side embedded member 30A are bonded by welding. However, the first movable bonding portion 7AQ and the first base-side bonding portion 30AQ of the first base-side embedded member 30A may be bonded with a conductive adhesive, solder, or the like. The same applies to: the bonding between the second movable bonding portion 7BQ and the second base-side bonding portion 30BQ; the bonding between the third movable bonding portion 7CQ and the third base-side bonding portion 30CQ; the bonding between the fourth movable bonding portion 7DQ and the fourth base-side bonding portion 30DQ; the bonding between the fifth movable bonding portion 7EQ and the fifth base-side bonding portion 30EQ; the bonding between the sixth movable bonding portion 7FQ and the sixth base-side bonding portion 30FQ; the bonding between the seventh movable bonding portion 7GQ and the seventh base-side bonding portion 30GQ; and the bonding between the eighth movable bonding portion 7HQ and the eighth base-side bonding portion 30HQ.

The supported-side metal member 5N is fixed to the lower end surface of the protruding portion 3T of the base member 3. Specifically, the first supported-side metal member 5N1 is fixed to the lower end surface of the first protruding portion 3T1, and the second supported-side metal member 5N2 is fixed to the lower end surface of the second protruding portion 3T2. More specifically, the first supported-side metal member 5N1 is formed with two through holes through which two projections 3W formed on the lower surface of the first protruding portion 3T1 and protruding downward are inserted. The first supported-side metal member 5N1 and the first protruding portion 311 are bonded to each other with an adhesive. However, the bonding between the first supported-side metal member 5N1 and the first protruding portion 311 may be realized by performing thermal caulking or cold caulking on the projection 3W. The first supported-side metal member 5N1 is formed with a round-cornered quadrangular through hole used at the time of welding. The first supported-side metal member 5N1 and the seventh wire-side bonding portion 30GP exposed on the lower surface of the first protruding portion 3T1 are bonded by welding. However, the bonding between the first supported-side metal member 5N1 and the seventh wire-side bonding portion 30GP may be realized through a conductive adhesive or the like. The same applies to the bonding between the second supported-side metal member 5N2 and the eighth wire-side bonding portion 30HP.

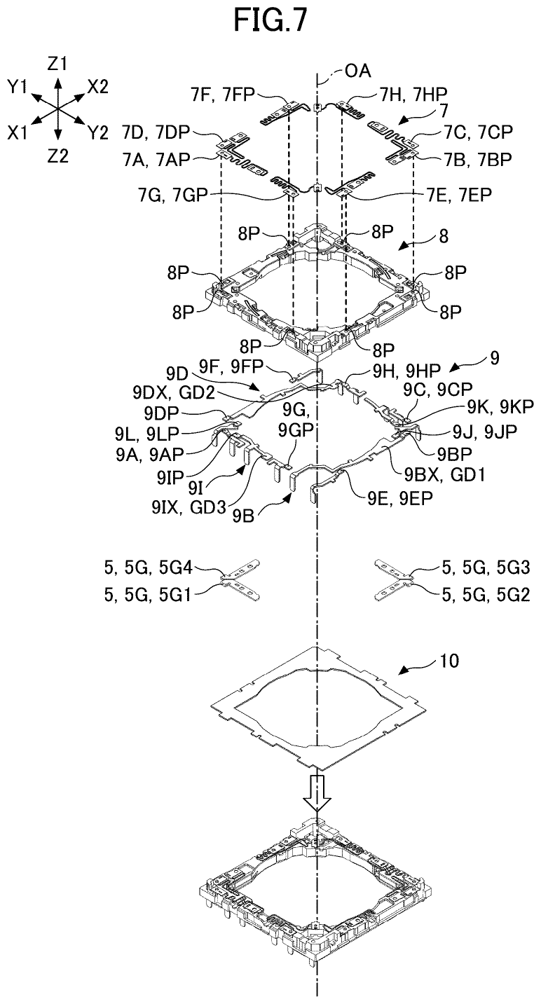

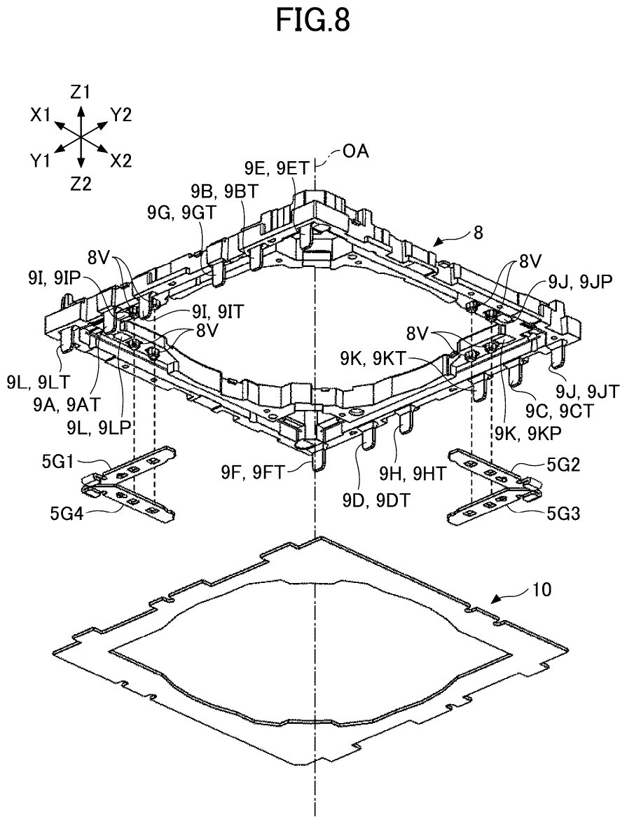

Next, a positional relationship between the members attached to the support member 8 and the support member 8 will be described with reference to FIGS. 7 and 8. FIG. 7 is a top perspective view of the supporting-side metal member 5G, the flexible metal member 7, the support member 8, the supporting-side embedded member 9, and the magnetic member 10. Specifically, the top diagram of FIG. 7 (the diagram above the block arrow) is an exploded perspective view, and the bottom diagram of FIG. 7 (the diagram below the block arrow) is an assembled perspective view. FIG. 8 is a bottom perspective view of the supporting-side metal member 5G, the support member 8, the supporting-side embedded member 9, and the magnetic member 10. The magnetic member 10 is bonded and fixed to the support member 8 so as not to come into contact with any of the supporting-side metal member 5G and the supported-side metal member 5N.

As illustrated in FIG. 7, the first flexible metal member 7A through the eighth flexible metal member 7H respectively have a first fixed bonding portion 7AP through an eighth fixed bonding portion 7HP. The first supporting-side embedded member 9A through the twelfth supporting-side embedded member 9L respectively have a first terminal 9AT through a twelfth terminal 9LT as illustrated in FIG. 8, and a first bonding portion 9AP through a twelfth bonding portion 9LP as illustrated in FIG. 7. The first bonding portion 9AP through the eighth bonding portion 9HP are exposed on the upper surface of the support member 8 (the base portion 8B), and the ninth bonding portion 9IP through the twelfth bonding portion 9LP are exposed on the lower surface of the support member 8.

Each of the first fixed bonding portion 7AP through the eighth fixed bonding portion 7HP is formed with a through hole through which a round projection 8P formed on the upper surface of the support member 8 and projecting upward is inserted. In the illustrated example, the flexible metal member 7 (the first fixed bonding portion 7AP) and the support member 8 (the projection 8P) are bonded to each other with an adhesive. However, the flexible metal member 7 (the first fixation bonding portion 7AP) and the support member 8 (the projection 8P) may be bonded by performing thermal caulking or cold caulking on the projection 8P. The same applies to the second fixed bonding portion 7BP to the eighth fixed bonding portion 7HP.

A round-cornered quadrangular through hole used at the time of welding is formed in each of the first fixed bonding portion 7AP through the eighth fixed bonding portion 7HP. The first fixed bonding portion 7AP and the first bonding portion 9AP are bonded by welding. However, the first fixed bonding portion 7AP and the first bonding portion 9AP may be bonded with a conductive adhesive or the like. The same applies to: the bonding between the second fixed bonding portion 7BP and the second bonding portion 9BP; the bonding between the third fixed bonding portion 7CP and the third bonding portion 9CP; the bonding between the fourth fixed bonding portion 7DP and the fourth bonding portion 9DP; the bonding between the fifth fixed bonding portion 7EP and the fifth bonding portion 9EP; the bonding between the sixth fixed bonding portion 7FP and the sixth bonding portion 9FP; the bonding between the seventh fixed bonding portion 7GP and the seventh bonding portion 9GP; and the bonding between the eighth fixed bonding portion 7HP and the eighth bonding portion 9HP.

A part of the supporting-side embedded member 9 (the second supporting-side embedded member 9B, the fourth supporting-side embedded member 9D, and the ninth supporting-side embedded member 9I) has an exposed portion (a second exposed portion 9BX, a fourth exposed portion 9DX, and a ninth exposed portion 9IX) exposed on the upper surface of the support member 8. As illustrated in FIG. 6, the base member 3 has a plurality of contact portions 3C (guided portions GE) which protrude downward from the main body portion 3B and whose distal end portions come into contact with the guide portions GD, which are parts of the exposed portions of the supporting-side embedded member 9. In the illustrated example, the guided portion GE includes: a first guided portion GE1 that contacts the upper surface of the first guide portion GD1 that is a part of the second exposed portion 9BX of the second supporting-side embedded member 9B; a second guided portion GE2 that contacts the upper surface of the second guide portion GD2 that is a part of the fourth exposed portion 9DX of the fourth supporting-side embedded member 9D; and a third guided portion GE3 that contacts the upper surface of the third guide portion GD3 that is a part of the ninth exposed portion 9IX of the ninth supporting-side embedded member 9I.

This configuration provides an effect that the supporting-side embedded member 9 can be used as the guide portion GD when the base member 3 is moved in the directions (the X-axis direction and the Y-axis direction) perpendicular to the optical axis direction. In other words, this configuration provides an effect that the supporting-side embedded member 9 which is less likely to be deformed than a synthetic resin can be used as the guide portion GD. Furthermore, sliding between a metal (the supporting-side embedded member 9) and a synthetic resin (the base member 3) can suppress the synthetic resin from being scraped, compared to a case where synthetic resins slide on each other. Therefore, this configuration provides an effect that abrasion powder is less likely to be generated.

As illustrated in FIG. 8, the fourth supporting-side metal member 5G4 is fixed to the support member 8 with an adhesive in a state where two rectangular projections 8V formed on the lower surface of the support member 8 and protruding downward (toward the Z2 side) are engaged with two rectangular holes formed in the fourth supporting-side metal member 5G4. However, the bonding between the fourth supporting-side metal member 5G4 and the support member 8 may be realized by performing thermal caulking or cold caulking on the projections 8V. The same applies to each of the first to third supporting-side metal members 5G1 through 5G3.

As illustrated in FIG. 8, a round-cornered quadrangular through hole used at the time of welding is formed in the first supporting-side metal member 5G1. The bonding between the first support metal member 5G1 and the ninth bonding portion 9IP of the ninth supporting-side embedded member 9I is realized by welding. However, the bonding between the first supporting-side metal member 5G1 and the ninth bonding portion 9IP may be realized through a conductive adhesive or the like. The same applies to the bonding between the second supporting-side metal member 5G2 and the tenth bonding portion 9JP of the tenth supporting-side embedded member 9J, the bonding between the third supporting-side metal member 5G3 and the eleventh bonding portion 9KP of the eleventh supporting-side embedded member 9K, and the bonding between the fourth supporting-side metal member 5G4 and the twelfth bonding portion 9LP of the twelfth supporting-side embedded member 9L.

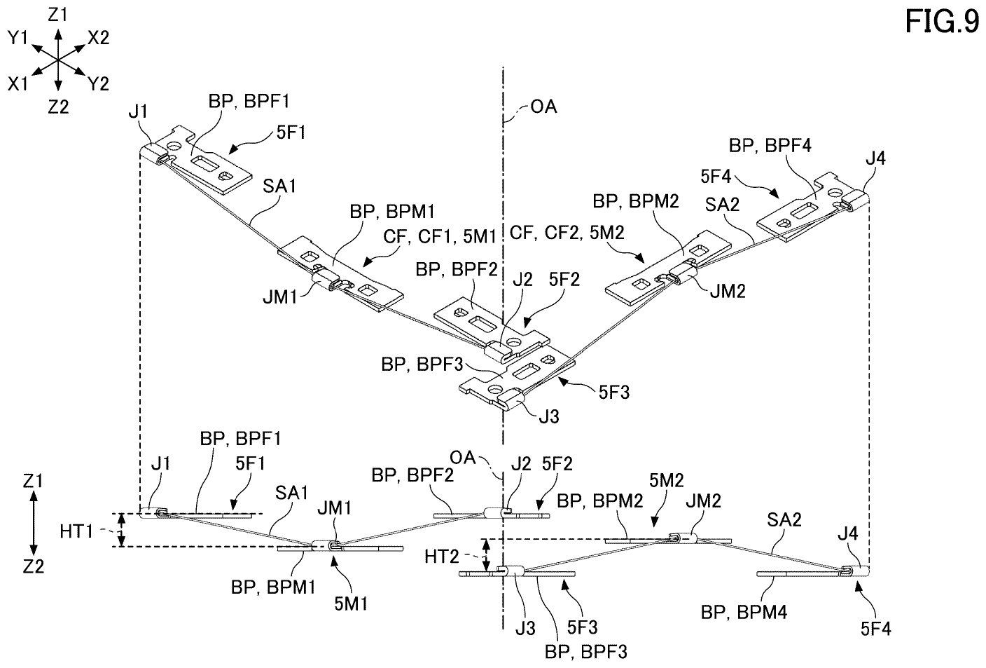

Next, the metal member 5 to which the shape memory alloy wire SA is attached will be described with reference to FIG. 9. FIG. 9 is a diagram illustrating a configuration example of the base-side metal member 5F, the lens-side metal member 5M, and the shape memory alloy wire SA. Specifically, the top diagram of FIG. 9 is a perspective view of the first base-side metal member 5F1 through the fourth base-side metal member 5F4, the first lens-side metal member 5M1, the second lens-side metal member 5M2, the first wire SA1, and the second wire SA2. The bottom diagram of FIG. 9 is a diagram of the first base-side metal member 5F1 through the fourth base-side metal member 5F4, the first lens-side metal member 5M1, the second lens-side metal member 5M2, the first wire SA1, and the second wire SA2 when viewed from the front right side along the direction perpendicular to the optical axis OA. The positional relationship of the members illustrated in FIG. 9 corresponds to the positional relationship when the lens driving device 101 is in the neutral state. The following description with reference to FIG. 9 can be similarly applied to the fifth base-side metal member 5F5 through the eighth base-side metal member 5F8, the third lens-side metal member 5M3, the fourth lens-side metal member 5M4, the third wire SA3, and the fourth wire SA4.

Specifically, one end portion of the first wire SA1 is fixed to the first base-side metal member 5F1 at the holding portion J1 of the first base-side metal member 5F1, the other end portion of the first wire SA1 is fixed to the second base-side metal member 5F2 at the holding portion J2 of the second base-side metal member 5F2, and the intermediate portion of the first wire SA1 is fixed to the first lens-side metal member 5M1 at the holding portion JM1 of the first lens-side metal member 5M1. Similarly, one end of the second wire SA2 is fixed to the third base-side metal member 5F3 at the holding portion J3 of the third base-side metal member 5F3, the other end of the second wire SA2 is fixed to the fourth base-side metal member 5F4 at the holding portion J4 of the fourth base-side metal member 5F4, and the intermediate portion of the second wire SA2 is fixed to the second lens-side metal member 5M2 at the holding portion JM2 of the second lens-side metal member 5M2.

The holding portion J1 is formed by bending a part of the first base-side metal member 5F1. Specifically, a part of the first base-side metal member 5F1 is bent in a state where one end portion of the first wire SA1 is sandwiched, thereby forming the holding portion J1. One end of the first wire SA1 is welded to the holding portion J1. The same applies to the holding portions J2 through J4, the holding portion JM1, and the holding portion JM2. As illustrated in the bottom diagram of FIG. 9, the first wire SA1 is arranged so as to form a substantially V shape in a front view, and the second wire SA2 is arranged so as to form a substantially inverted V shape in a right-side view.

The base member 3 is configured to function as a wire support member that supports both ends (one end portion and the other end portion) of each of the first wire SA1 through the fourth wire SA4. With this configuration, the lens holding member 2 is connected to the base member 3 via the first wire SA1 through the fourth wire SA4 in a state of being movable in the optical axis direction (the Z-axis direction), which is a direction parallel to the optical axis OA.

In the illustrated example, each of the base-side metal member 5F and the lens-side metal member 5M is formed of a metallic plate having a plate-shaped base portion BP. In detail, the first base-side metal member 5F1 has a base portion BPF1; the second base-side metal member 5F2 has a base portion BPF2; the third base-side metal member 5F3 has a base portion BPF3; the fourth base-side metal member 5F4 has a base portion BPF4; the first lens-side metal member 5M1 has a base portion BPM1; and the second lens-side metal member 5M2 has a base portion BPM2. As illustrated in the bottom diagram of FIG. 9, the first base-side metal member 5F1, the second base-side metal member 5F2, the third base-side metal member 5F3, the fourth base-side metal member 5F4, the first lens-side metal member 5M1, and the second lens-side metal member 5M2 are attached to the lens holding member 2 or the base member 3 so that the plate surfaces of the base portion BPF1, the base portion BPF2, the base portion BPF3, the base portion BPF4, the base portion BPM1, and the base portion BPM2 are parallel to the XY plane, in other words, substantially parallel to each other. The first base-side metal member 5F1 and the second base-side metal member 5F2 are arranged at a position higher than the first lens-side metal member 5M1 in the Z-axis direction, and the third base-side metal member 5F3 and the fourth base-side metal member 5F4 are arranged at a position lower than the second lens-side metal member 5M2 in the Z-axis direction. The first lens-side metal member 5M1 is arranged at a position lower than the second lens-side metal member 5M2 in the Z-axis direction.

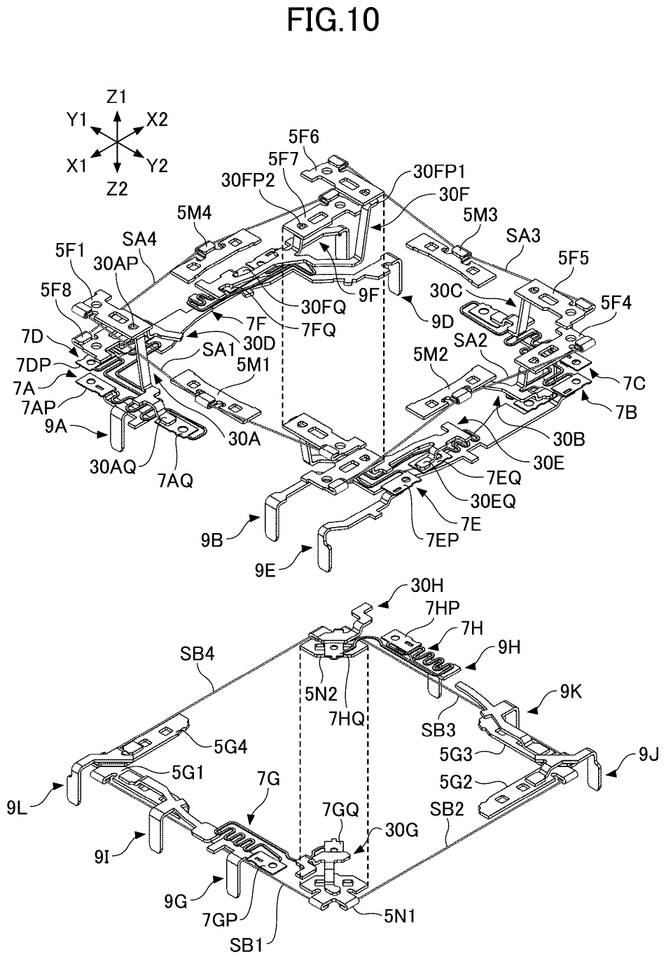

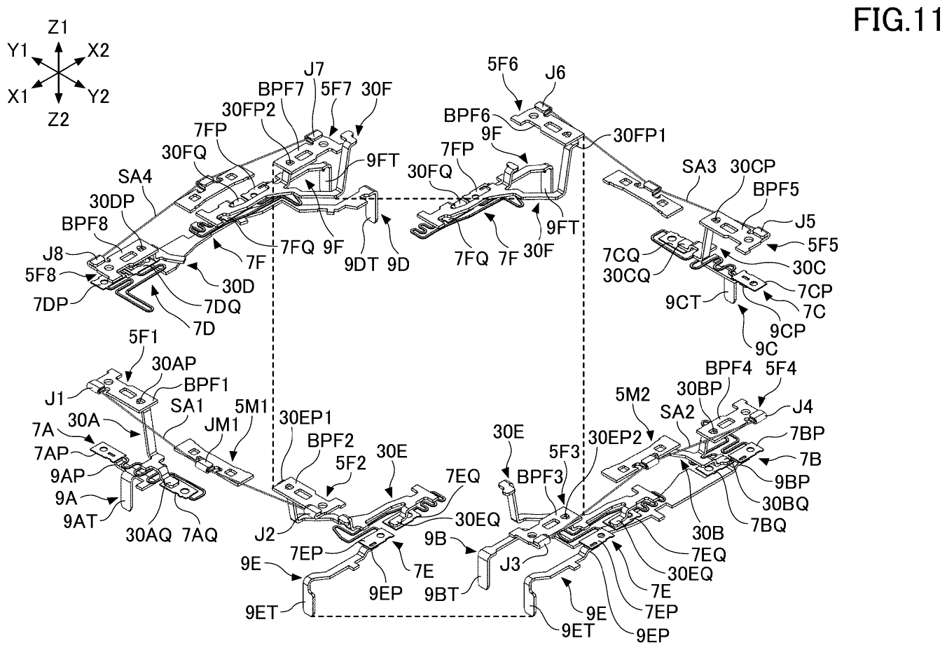

Next, with reference to FIGS. 10, 11, and 12, a positional relationship among the metal member 5, the flexible metal member 7, the supporting-side embedded member 9, the shape memory alloy wire SA, the shape memory alloy wire SB, and the base-side embedded member 30, which are members through which a current flows, will be described. FIG. 10 is a perspective view of the metal member 5, the flexible metal member 7, the supporting-side embedded member 9, the shape memory alloy wire SA, the shape memory alloy wire SB, and the base-side embedded member 30. Specifically, the top diagram of FIG. 10 is a perspective view of members related to a current path including the shape memory alloy wire SA, and the bottom diagram of FIG. 10 is a perspective view of members related to a current path including the shape memory alloy wire SB. FIG. 11 is a diagram of a part extracted from the top diagram of FIG. 10, in which the bottom left diagram of FIG. 11 illustrates members related to the current path including the first wire SA1, the bottom right diagram of FIG. 11 illustrates members related to the current path including the second wire SA2, the top right diagram of FIG. 11 illustrates members related to the current path including the third wire SA3, and the top left diagram of

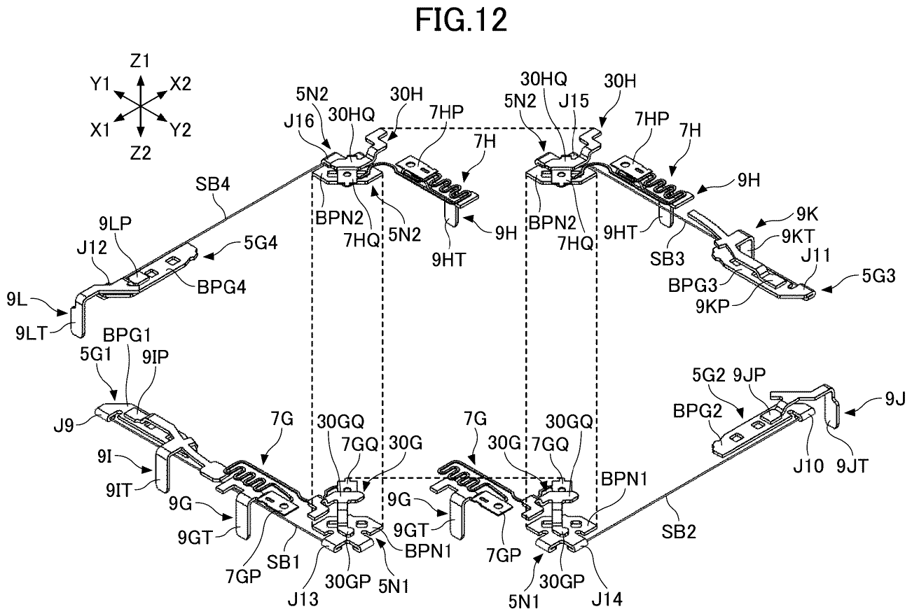

FIG. 11 illustrates members related to the current path including the fourth wire SA4. FIG. 12 is a diagram of a part extracted from the bottom diagram of FIG. 10, in which the bottom left diagram of FIG. 12 illustrates members related to the current path including the first wire SB1, the bottom right diagram of FIG. 12 illustrates members related to the current path including the second wire SB2, the top right diagram of FIG. 12 illustrates members related to the current path including the third wire SB3, and the top left diagram of FIG. 12 illustrates members related to the current path including the fourth wire SB4.

As illustrated in the bottom left diagram of FIG. 11, when the first terminal 9AT of the first supporting-side embedded member 9A is connected to a high potential and the fifth terminal 9ET of the fifth supporting-side embedded member 9E is connected to a low potential, a current flows from the first terminal 9AT of the first supporting-side embedded member 9A to the fifth terminal 9ET of the fifth supporting-side embedded member 9E, through the first bonding portion 9AP of the first supporting-side embedded member 9A, the first flexible metal member 7A (the first fixed bonding portion 7AP and the first movable bonding portion 7AQ), the first base-side embedded member 30A (the first base-side bonding portion 30AQ and the first wire-side bonding portion 30AP), and the first base-side metal member 5F1 (the base portion BPF1 and the holding portion J1), the first wire SA1, the second base-side metal member 5F2 (the holding portion J2 and the base portion BPF2), the fifth base-side embedded member 30E (the fifth upper wire-side embedded portion 30EP1 and the fifth base-side bonding portion 30EQ), the fifth flexible metal member 7E (the fifth movable bonding portion 7EQ and the fifth fixed bonding portion 7EP), and the fifth bonding portion 9EP of the fifth supporting-side embedded member 9E.

As illustrated in the bottom right drawing of FIG. 11, when the second terminal 9BT of the second supporting-side embedded member 9B is connected to a high potential and the fifth terminal 9ET of the fifth supporting-side embedded member 9E is connected to a low potential, a current flows from the second terminal 9BT of the second supporting-side embedded member 9B to the fifth terminal 9ET of the fifth supporting-side embedded member 9E, through the second bonding portion 9BP of the second supporting-side embedded member 9B, the second flexible metal member 7B (the second fixed bonding portion 7BP and the second movable bonding portion 7BQ), the second base-side embedded member 30B (the second base-side bonding portion 30BQ and the second wire-side bonding portion 30BP), the fourth base-side metal member 5F4 (the base portion BPF4 and the holding portion J4), the second wire SA2, the third base-side metal member 5F3 (the holding portion J3 and the base portion BPF3), the fifth base-side embedded member 30E (the fifth lower wire-side bonding portion 30EP2 and the fifth base-side bonding portion 30EQ), the fifth flexible metal member 7E (the fifth movable bonding portion 7EQ and the fifth fixed bonding portion 7EP), and the fifth bonding portion 9EP of the fifth supporting-side embedded member 9E.

In both cases where the first terminal 9AT of the first supporting-side embedded member 9A is connected to a high potential and where the second terminal 9BT of the second supporting-side embedded member 9B is connected to a high potential, the path of the current flowing from the fifth base-side bonding portion 30EQ of the fifth base-side embedded member 30E to the fifth terminal 9ET of the fifth supporting-side embedded member 9E is the same.

As illustrated in the top right drawing of FIG. 11, when the third terminal 9CT of the third supporting-side embedded member 9C is connected to a high potential and the sixth terminal 9FT of the sixth supporting-side embedded member 9F is connected to a low potential, a current flows from the third terminal 9CT of the third supporting-side embedded member 9C to the sixth terminal 9FT of the sixth supporting-side embedded member 9F, through the third bonding portion 9CP of the third supporting-side embedded member 9C, the third flexible metal member 7C (the third fixed bonding portion 7CP and the third movable bonding portion 7CQ), the third base-side embedded member 30C (the third base-side bonding portion 30CQ and the third wire-side bonding portion 30CP), the fifth base-side metal member 5F5 (the base portion BPF5 and the holding portion J5), the third wire SA3, the sixth base-side metal member 5F6 (the holding portion J6 and the base portion BPF6), the sixth base-side embedded member 30F (the sixth upper wire-side bonding portion 30FP1 and the sixth base-side bonding portion 30FQ), the sixth flexible metal member 7F (the sixth movable bonding portion 7FQ and the sixth fixed bonding portion 7FP), and the sixth bonding portion 9FP of the sixth supporting-side embedded member 9F (see FIG. 6).

As illustrated in the top left drawing of FIG. 11, when the fourth terminal 9DT of the fourth supporting-side embedded member 9D is connected to a high potential and the sixth terminal 9FT of the sixth supporting-side embedded member 9F is connected to a low potential, a current flows from the fourth terminal 9DT of the fourth supporting-side embedded member 9D to the sixth terminal 9FT of the sixth supporting-side embedded member 9F, through the fourth bonding portion 9DP of the fourth supporting-side embedded member 9D (see FIG. 6), the fourth flexible metal member 7D (the fourth fixed bonding portion 7DP and the fourth movable bonding portion 7DQ), the fourth base-side embedded member 30D (the fourth base-side bonding portion 30DQ (see FIG. 6) and the fourth wire-side bonding portion 30DP), the eighth base-side metal member 5F8 (the base portion BPF8 and the holding portion J8), the fourth wire SA4, the seventh base-side metal member 5F7 (the holding portion J7 and the base portion BPF7), the sixth base-side embedded member 30F (the sixth lower wire-side bonding portion 30FP2 and the sixth base-side bonding portion 30FQ), the sixth flexible metal member 7F (the sixth movable bonding portion 7FQ and the sixth fixed bonding portion 7FP), and the sixth bonding portion 9FP of the sixth supporting-side embedded member 9F (see FIG. 6).

In both cases where the third terminal 9CT of the third supporting-side embedded member 9C is connected to a high potential and where the fourth terminal 9DT of the fourth supporting-side embedded member 9D is connected to a high potential, the path of the current flowing from the sixth base-side bonding portion 30FQ of the sixth base-side embedded member 30F to the sixth terminal 9FT of the sixth supporting-side embedded member 9F is the same.

As illustrated in the bottom left drawing of FIG. 12, when the ninth terminal 9IT of the ninth supporting-side embedded member 9I is connected to a high potential and the seventh terminal 9GT of the seventh supporting-side embedded member 9G is connected to a low potential, a current flows from the ninth terminal 9IT of the ninth supporting-side embedded member 9I to the seventh terminal 9GT of the seventh supporting-side embedded member 9G, through the ninth bonding portion 9IP of the ninth supporting-side embedded member 9I, the first supporting-side metal member 5G1 (the base portion BPG1 and the holding portion J9), the first wires SB1, the first supported-side metal members 5N1 (the holding portion J13 and the base portion BPN1), the seventh base-side embedded member 30G (the seventh wire-side bonding portion 30GP and the seventh base-side bonding portion 30GQ), the seventh flexible metal member 7G (the seventh movable bonding portion 7GQ and the seventh fixed bonding portion 7GP), and the seventh bonding portion 9GP of the seventh supporting-side embedded member 9G (see FIG. 7).

As illustrated in the lower right drawing of FIG. 12, when the tenth terminal 9JT of the tenth supporting-side embedded member 9J is connected to a high potential and the seventh terminal 9GT of the seventh supporting-side embedded member 9G is connected to a low potential, a current flows from the tenth terminal 9JT of the tenth supporting-side embedded member 9J to the seventh terminal 9GT of the seventh supporting-side embedded member 9G, through the tenth bonding portion 9JP of the tenth supporting-side embedded member 9J, the second supporting-side metal member 5G2 (the base portion BPG2 and the holding portion J10), the second wire SB2, the first supported-side metal member 5N1 (the holding portion J14 and the base portion BPN1), the seventh base-side embedded member 30G (the seventh wire-side bonding portion 30GP and the seventh base-side bonding portion 30GQ), the seventh flexible metal member 7G (the seventh movable bonding portion 7GQ and the seventh fixed bonding portion 7GP), and the seventh bonding portion 9GP of the seventh supporting-side embedded member 9G (see FIG. 7).

In both cases where the ninth terminal 9IT of the ninth supporting-side embedded member 9I is connected to a high potential and where the tenth terminal 9JT of the tenth supporting-side embedded member 9J is connected to a high potential, the path of the current flowing from the first supported-side metal member 5N1 to the seventh terminal 9GT of the seventh supporting-side embedded member 9G is the same.

As illustrated in the top right drawing of FIG. 12, when the eleventh terminal 9KT of the eleventh supporting-side embedded member 9K is connected to a high potential and the eighth terminal 9HT of the eighth supporting-side embedded member 9H is connected to a low potential, a current flows from the eleventh terminal 9KT of the eleventh supporting-side embedded member 9K to the eighth terminal 9HT of the eighth supporting-side embedded member 9H, through the eleventh bonding portion 9KP of the eleventh supporting-side embedded member 9K, the third supporting-side metal member 5G3 (the base portion BPG3 and the holding portion J11), the third wire SB3, the second supported-side metal member 5N2 (the holding portion J15 and the base portion BPN2), the eighth base-side embedded member 30H (the eighth wire-side bonding portion 30HP (see FIG. 6) and the eighth base-side bonding portion 30HQ), the eighth flexible metal member 7H (the eight movable bonding portion 7HQ and the eighth fixed bonding portion 7HP), and the eighth bonding portion 9HP (see FIG. 6) of the eighth supporting-side embedded member 9H.

As illustrated in the top left drawing of FIG. 12, when the twelfth terminal 9LT of the twelfth supporting-side embedded member 9L is connected to a high potential and the eighth terminal 9HT of the eighth supporting-side embedded member 9H is connected to a low potential, a current flows from the twelfth terminal 9LT of the twelfth supporting-side embedded member 9L to the eighth terminal 9HT of the eighth supporting-side embedded member 9H through the twelfth bonding portion 9LP of the twelfth supporting-side embedded member 9L, the fourth supporting-side metal member 5G4 (the base portion BPG4 and the holding portion J12), the fourth wire SB4, the second supported-side metal member 5N2 (the holding portion J16 and the base portion BPN2), the eighth base-side embedded member 30H (the eighth wire-side bonding portion 30HP (see FIG. 6) and the eighth base-side bonding portion 30HQ), the eighth flexible metal member 7H (the eight movable bonding portion 7HQ and the eighth fixed bonding portion 7HP), and the eighth bonding portion 9HP of the eighth supporting-side embedded member 9H (see FIG. 6).

In both cases where the eleventh terminal 9KT of the eleventh supporting-side embedded member 9K is connected to a high potential and where the twelfth terminal 9LT of the twelfth supporting-side embedded member 9L is connected to a high potential, the path of the current flowing from the second supported-side metal member 5N2 to the eighth terminal 9HT of the eighth supporting-side embedded member 9H is the same.

The control device provided outside the lens driving device 101 as described above can control the lengths of the shape memory alloy wire SA (the first wire SA1 through the fourth wire SA4) and the shape memory alloy wire SB (the first wire SB1 through the fourth wire SB4) by controlling the voltages applied to the terminals (the first terminal 9AT through the twelfth terminal 9LT) of the first supporting-side embedded member 9A through the twelfth supporting-side embedded member 9L. For example, the control device may detect the electrical resistance value of each of the shape memory alloy wires and control the length of each of the shape memory alloy wires in accordance with the detection result. The control device may be arranged in the lens driving device 101. The control device may be a component of the lens driving device 101.

The control device may move the lens holding member 2 along the direction parallel to the optical axis OA (the Z-axis direction) on the Z1 side (subject side) of the image sensor IS by using the driving force along the direction parallel to the optical axis OA due to the contraction of the shape memory alloy wire SA as the first driver DM1, for example. The control device may realize an automatic focus adjustment function, which is one of the lens adjustment functions, by moving the lens holding member 2 in this way. Specifically, the control device may enable macro imaging by moving the lens holding member 2 in a direction away from an image sensor, and enable infinite imaging by moving the lens holding member 2 in a direction toward the image sensor.

The control device may move the lens holding member 2 in the direction intersecting the optical axis OA (each of the X-axis direction and the Y-axis direction) by controlling the current flowing through the shape memory alloy wire SB as the second driver DM2. Thus, the control device may realize a camera shake correction function.

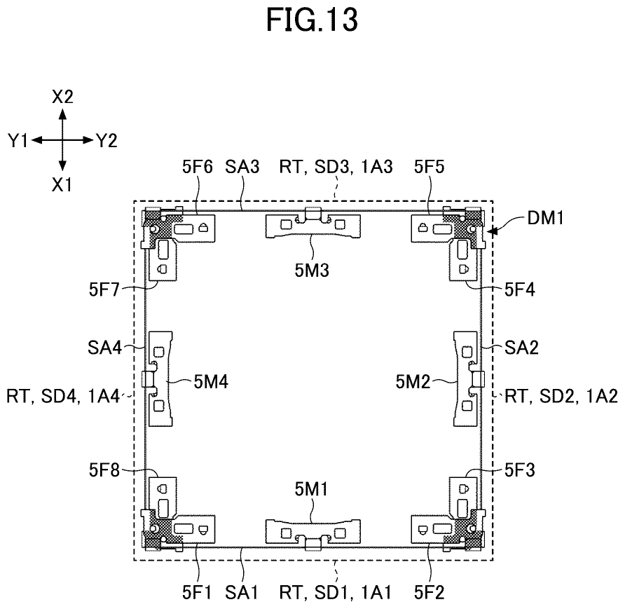

Next, the positional relationship between the base-side metal member 5F and the lens-side metal member 5M constituting the first driver DM1 will be described with reference to FIG. 13. FIG. 13 is a top view of the first driver DM1. The first driver DM1 includes the first wire SA1 through the fourth wire SA4, the first base-side metal member 5F1 through the eighth base-side metal member 5F8, and the first lens-side metal member 5M1 through the fourth lens-side metal member 5M4.

As illustrated in FIG. 13, the first driver DM1 is configured to be positioned inside a quadrangle RT represented by a broken line in the neutral state of the lens driving device 101 when viewed along the optical axis direction. The quadrangle RT corresponds to the inner surface of the outer peripheral wall portion 1A of the cover member 1. Specifically, the quadrangle RT includes the first side SD1 corresponding to the inner surface of the first side plate portion 1A1, the second side SD2 corresponding to the inner surface of the second side plate portion 1A2, the third side SD3 corresponding to the inner surface of the third side plate portion 1A3, and a fourth side SD4 corresponding to the inner surface of the fourth side plate portion 1A4.

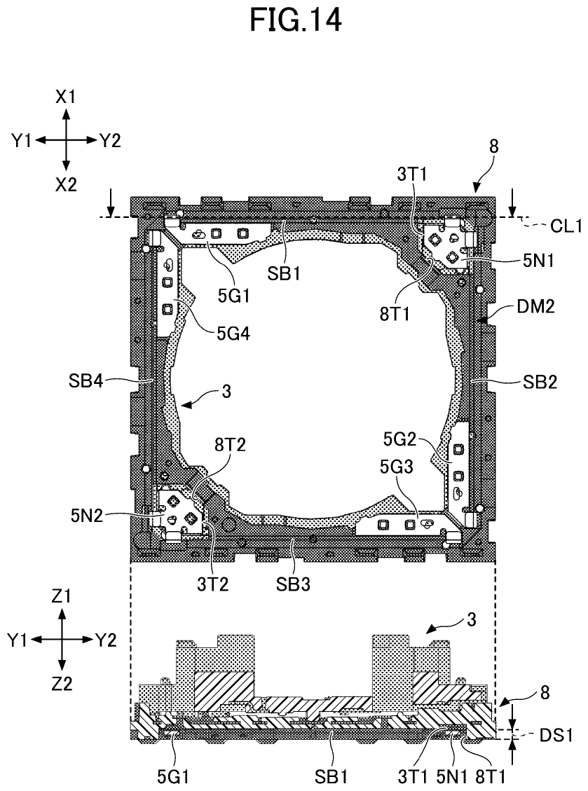

Next, the positional relationship between the second driver DM2 and each of the base member 3 and the support member 8 will be described with reference to FIG. 14. FIG. 14 is a diagram illustrating a positional relationship among the base member 3, the support member 8, and the second driver DM2. Specifically, the top diagram of FIG. 14 is a bottom view of the base member 3, the support member 8, and the second driver DM2, and the bottom diagram of FIG. 14 is a cross-sectional view of the base member 3, the support member 8, and the second driver DM2. Specifically, the bottom diagram of FIG. 14 is a view illustrating a cross section of the base member 3, the support member 8, and the second driver DM2 in the YZ plane including the section line CL1 in the top diagram of FIG. 14, as viewed from the X1 side.

As illustrated in the bottom diagram of FIG. 14, the base member 3 is configured such that the lower end surface of the protruding portion 3T (the first protruding portion 3T1) protrudes to a position at a distance DS1 from the lower surface of the support member 8 through the through portion 8T (the first through portion 8T1) of the support member 8 in the neutral state of the lens driving device 101. This is because the position (height) of the supported-side metal member 5N (the first supported-side metal member 5N1) and the position (height) of the supporting-side metal member 5G (the first supporting-side metal member 5G1 and the second supporting-side metal member 5G2) in the optical axis direction (the Z-axis direction) are set to be the same on the lower side of the support member 8.

With this configuration, the lens driving device 101 has an effect that the lens driving device 101 including the second driver DM2 (the shape memory alloy wire SB) arranged in the lower surface side of the support member 8 can be realized with a simple structure in which the protruding portion 3T is provided in the base member 3 and the through portion 8T is provided in the support member 8. In particular, this configuration provides an effect that the assembly of the supported-side metal member 5N of the second driver DM2 to the base member 3 and the assembly of the supporting-side metal member 5G of the second driver DM2 to the support member 8 can be realized by a simple structure.

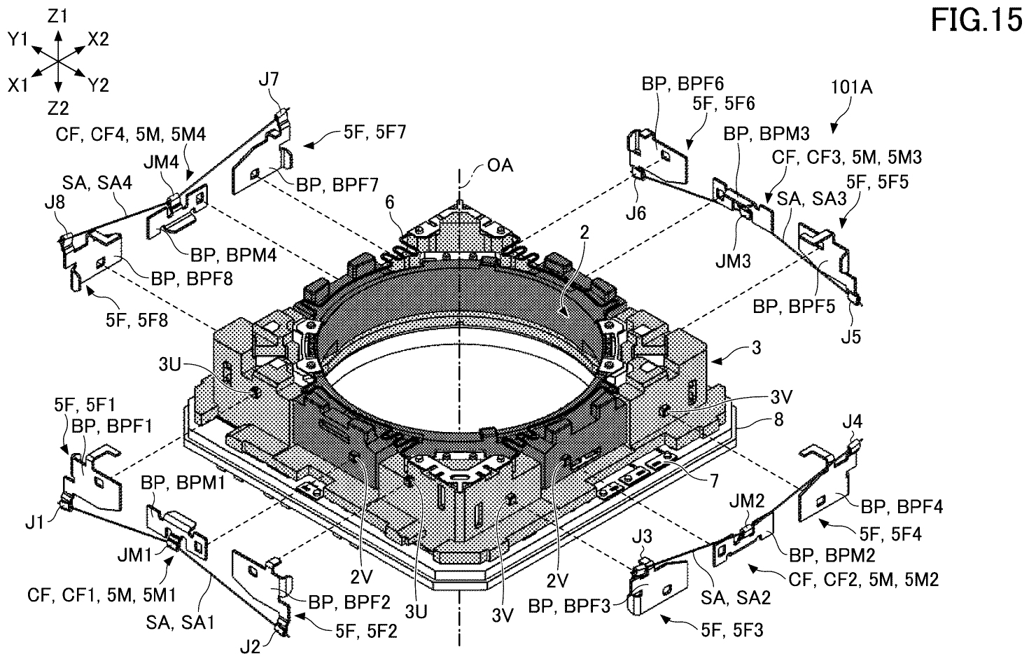

Next, a lens driving device 101A, which is another configuration example of the lens driving device 101 according to the embodiment of the present disclosure, will be described with reference to FIG. 15. FIG. 15 is a perspective view of the lens driving device 101A. In FIG. 15, for the sake of clarity, the cover member 1 is not illustrated, and the first driver DM1 (the base-side metal member 5F, the lens-side metal member 5M, and the shape memory alloy wire SA) is illustrated in a state of being removed from other members.

The lens driving device 101A is different from the lens driving device 101 mainly in that the base-side metal member 5F is attached to the side surface of the base member 3 and the lens-side metal member 5M is attached to the side surface of the lens holding member 2. In the lens driving device 101, the base-side metal member 5F is attached to the upper surface of the base member 3, and the lens-side metal member 5M is attached to the upper surface of the lens holding member 2.

Specifically, in the lens driving device 101A, each of the first base-side metal member 5F1 through the eighth base-side metal member 5F8 and the first lens-side metal member 5M1 through the fourth lens-side metal member 5M4 is configured by a metallic plate having a plate-shaped base portion BP, similarly to the case of the lens driving device 101. Each of the first base-side metal member 5F1 through the eighth base-side metal member 5F8 and the first lens-side metal member 5M1 through the fourth lens-side metal member 5M4 is configured in such a manner that the plate surface of the base portion BP is substantially parallel to the optical axis OA, unlike the case of the lens driving device 101.

More specifically, the first base-side metal member 5F1, the second base-side metal member 5F2, and the first lens-side metal member 5M1 are arranged in such a manner that that the plate surfaces of the base portion BPF1, the base portion BPF2, and the base portion BPM1 are substantially parallel to each other. The third base-side metal member 5F3, the fourth base-side metal member 5F4, and the second lens-side metal member 5M2 are arranged in such a manner that that the plate surfaces of the base portion BPF3, the base portion BPF4, and the base portion BPM2 are substantially parallel to each other. The fifth base-side metal member 5F5, the sixth base-side metal member 5F6, and the third lens-side metal member 5M3 are arranged in such a manner that that the plate surfaces of the base portion BPF5, the base portion BPF6, and the base portion BPM3 are substantially parallel to each other. The seventh base-side metal member 5F7, the eighth base-side metal member 5F8, and the fourth lens-side metal member 5M4 are arranged in such a manner that that the plate surfaces of the base portion BPF7, the base portion BPF8, and the base portion BPM4 are substantially parallel to each other. Each of the first wire SA1 through the fourth wire SA4 is configured to be linear when energized in a plan view along the optical axis direction. The first wire SA is arranged so as to form a substantially inverted V shape in a front view; the second wire SA2 is arranged so as to form a substantially V shape in a right-side view; the third wire SA3 is arranged so as to form a substantially inverted V shape in a rear view; and the fourth wire SA4 is arranged so as to form a substantially V shape in a left-side view. The first base-side metal member 5F1 and the second base-side metal member 5F2 are arranged such that the position (height) of the holding portion J1 and the position (height) of the holding portion J2 are the same in the Z-axis direction. The same applies to the positional relationship between the third base-side metal member 5F3 and the fourth base-side metal member 5F4, the positional relationship between the fifth base-side metal member 5F5 and the sixth base-side metal member 5F6, and the positional relationship between the seventh base-side metal member 5F7 and the eighth base-side metal member 5F8. The first lens-side metal member 5M1 and the second lens-side metal member 5M2 are arranged such that the position (height) of the holding portion JM1 is lower than the position (height) of the holding portion JM2 in the Z-axis direction. The same applies to the positional relationship between the third lens-side metal member 5M3 and the fourth lens-side metal member 5M4.

This configuration provides an effect that each of the first base-side metal member 5F1, the second base-side metal member 5F2, and the first lens-side metal member 5M1 can be attached to the corresponding member (the lens holding member 2 or the base member 3) from the same side (the front side in the illustrated example). Similarly, this configuration provides an effect that the third base-side metal member 5F3, the fourth base-side metal member 5F4, and the second lens-side metal member 5M2 can be attached to the corresponding member (the lens holding member 2 or the base member 3) from the same side (the right side in the illustrated example), the fifth base-side metal member 5F5, the sixth base-side metal member 5F6, and the third lens-side metal member 5M3 can be attached to the corresponding member (the lens holding member 2 or the base member 3) from the same side (the rear side in the illustrated example), and the seventh base-side metal member 5F7, the eighth base-side metal member 5F8, and the fourth lens-side metal member 5M4 can be attached to the corresponding member (the lens holding member 2 or the base member 3) from the same side (the left side in the illustrated example). Therefore, this configuration can improve the productivity (assemblability) of the lens driving device 101.

As described above, according to the embodiment of the present disclosure, as illustrated in FIG. 2, the lens driving device 101 includes the base member 3, the lens holding member 2 having the cylindrical portion 2C capable of holding the lens body LS, and the driver DM (the first driver DM1) having the shape memory alloy wire SA for moving the lens holding member 2 in the vertical direction along the optical axis direction with respect to the base member 3. The shape memory alloy wire SA includes the first wire SA1. The base member 3 is provided with the first base-side metal member 5F1 and the second base-side metal member 5F2 which are arranged to be separated from each other in a first direction (the left-right direction, the Y-axis direction) intersecting with the optical axis direction. One end of the first wire SA1 may be fixed to the first base-side metal member 5F1, the other end of the first wire SA1 may be fixed to the second base-side metal member 5F2, and an intermediate portion of the first wire SA1 positioned between the one end and the other end of the first wire SA1 may be fixed to the first central fixing portion CF1 provided on the lens holding member 2. The first central fixing portion CF1 is arranged between the first base-side metal member 5F1 and the second base-side metal member 5F2 in a plan view along the optical axis direction. As illustrated in the bottom diagram of FIG. 9, the intermediate portion of the first wire SA1 in the optical axis direction is arranged at a position different from each of the one end portion and the other end portion of the first wire SA1. The same applies to the lens driving device 101A illustrated in FIG. 15. In the example illustrated in the drawings, the base member 3 is a part of the movable-side member MB, but may be a part of the fixed-side member FB.

This configuration provides an effect of suppressing the occurrence of a problem related to the holding of the shape memory alloy wire SA. For example, this configuration can suppress generation of abrasion powder or the like caused by the intermediate portion of the first wire SA1 sliding on another member. This is because the intermediate portion of the first wire SA1 is fixed to the first central fixing portion CF1, and the intermediate portion of the first wire SA1 does not slide on other members when the first wire SA1 is energized. Furthermore, this configuration can suppress the intermediate portion of the first wire SA1 from coming off the holding component (the first central fixing portion CF1) even when a strong impact due to dropping or the like is applied to the lens driving device 101. This is because the first wire SA1 is fixed to the first central fixing portion CF1.

The first central fixing portion CF1 may be configured by the first lens-side metal member 5M1 formed of a metallic material, as illustrated in FIG. 2. However, the first central fixing portion CF1 may be formed of materials other than metals, such as a synthetic resin. For example, the first central fixing portion CF1 may be a part of the lens holding member 2.

This configuration provides an effect that the intermediate portion of the first wire SA1 and the first central fixing portion CF1 can be more reliably bonded to each other than in the case where the first central fixing portion CF1 is formed of a non-metal material.

As illustrated in FIG. 9, each of the first base-side metal member 5F1, the second base-side metal member 5F2, and the first lens-side metal member 5M1 may be configured by a metal plate having a plate-shaped base portion BP. The plate surfaces of the base portions BP respectively constituting the first base-side metal member 5F1, the second base-side metal member 5F2, and the first lens-side metal member 5M1 may be substantially parallel to each other.

This configuration provides an effect that each of the first base-side metal member 5F1, the second base-side metal member 5F2, and the first lens-side metal member 5M1 can be attached to the corresponding member (the lens holding member 2 or the base member 3) from the same side (the upper side in the illustrated example). Therefore, this configuration can improve the productivity (assemblability) of the lens driving device 101.

As illustrated in the bottom diagram of FIG. 9, the intermediate portion of the first wire SA1 may be positioned at a position lower than each of the one end portion and the other end portion of the first wire SA1 in the optical axis direction. As illustrated in FIG. 2, the shape memory alloy wire SA may include a second wire SA2, and the base member 3 may be provided with a third base-side metal member 5F3 and a fourth base-side metal member 5F4 which are arranged to be separated in a second direction (the front-rear direction, the X-axis direction) intersecting the optical axis direction and perpendicular to the first direction (the Y-axis direction). One end of the second wire SA2 may be fixed to the third base-side metal member 5F3, and the other end of the second wire SA2 may be fixed to the fourth base-side metal member 5F4. In this case, an intermediate portion of the second wire SA2 positioned between the one end portion and the other end portion of the second wire SA2 may be fixed to the second lens-side metal member 5M2 as the second central fixing portion CF2 provided on the lens holding member 2. The second lens-side metal member 5M2 may be arranged between the third base-side metal member 5F3 and the fourth base-side metal member 5F4 in a plan view along the optical axis direction. As illustrated in the bottom diagram of FIG. 9, the intermediate portion of the second wire SA2 may be arranged at a position higher than each of the one end portion and the other end portion of the second wire SA2 in the optical axis direction. Each of the first wire SA1 and the second wire SA2 may be configured to be linear when energized in a plan view along the optical axis direction, as illustrated in FIG. 13. In the example illustrated in the bottom diagram of FIG. 9, the intermediate portion of the first wire SA1 is arranged at a position lower than each of the one end portion and the other end portion of the first wire SA1 by the height HT1. The intermediate portion of the second wire SA2 is arranged at a position higher than each of the one end portion and the other end portion of the second wire SA2 by the height HT2.

This configuration provides an effect that the position of the lens holding member 2 in the optical axis direction can be adjusted by two types of the shape memory alloy wires SA, that is, the first wire SA1 having a substantially V shape and the second wire SA2 having a substantially inverted V shape in a side view. Furthermore, this configuration can suppress generation of abrasion powder or the like caused by the intermediate portion of the second wire SA2 sliding on another member. This is because the intermediate portion of the second wire SA2 is fixed to the second lens-side metal member 5M2, and the intermediate portion of the second wire SA2 does not slide on other members when the second wire SA2 is energized. Furthermore, this configuration can suppress the intermediate portion of the second wire SA2 from coming off the holding component (the second lens-side metal member 5M2) even when a strong impact due to dropping or the like is applied to the lens driving device 101. This is because the second wire SA2 is fixed to the second lens-side metal member 5M2.

As illustrated in FIG. 9, each of the third base-side metal member 5F3, the fourth base-side metal member 5F4, and the second lens-side metal member 5M2 may be configured by a metal plate having a plate-shaped base portion BP. The plate surfaces of the base portions BP respectively constituting the third base-side metal member 5F3, the fourth base-side metal member 5F4, and the second lens-side metal member 5M2 may be substantially parallel to each other.

This configuration provides an effect that each of the third base-side metal member 5F3, the fourth base-side metal member 5F4, and the second lens-side metal member 5M2 can be attached to the corresponding member (the lens holding member 2 or the base member 3) from the same side (the upper side in the illustrated example). Therefore, this configuration can improve the productivity (assemblability) of the lens driving device 101.

As illustrated in FIG. 9, the first base-side metal member 5F1 and the third base-side metal member 5F3 may have the same shape and the same size, the second base-side metal member 5F2 and the fourth base-side metal member 5F4 may have the same shape and the same size, and the first lens-side metal member 5M1 and the second lens-side metal member 5M2 may have the same shape and the same size. The combination of the first base-side metal member 5F1, the second base-side metal member 5F2, and the first lens-side metal member 5M1 may be replaced with a combination of the third base-side metal member 5F3, the fourth base-side metal member 5F4, and the second lens-side metal member 5M2 that are arranged in an inverted manner. In other words, the combination of the third base-side metal member 5F3, the fourth base-side metal member 5F4, and the second lens-side metal member 5M2 may be obtained by vertically reversing the combination of the first base-side metal member 5F1, the second base-side metal member 5F2, and the first lens-side metal member 5M1 and rotating the combination by 90° counterclockwise about the optical axis OA.

This configuration provides an effect that the number of components can be reduced by sharing the components, compared to a case where the first base-side metal member 5F1, the second base-side metal member 5F2, the first lens-side metal member 5M1, the third base-side metal member 5F3, the fourth base-side metal member 5F4, and the second lens-side metal member 5M2 have different shapes or sizes.

As illustrated in FIG. 9, the plate surfaces of the base portions BP respectively constituting the first base-side metal member 5F1, the second base-side metal member 5F2, the third base-side metal member 5F3, the fourth base-side metal member 5F4, the first lens-side metal member 5M1, and the second lens-side metal member 5M2 may be substantially perpendicular to the optical axis direction.

This configuration provides an effect that all of the base-side metal members 5F and the lens-side metal members 5M can be attached to the base member 3 or the lens holding member 2 from the upper side. Therefore, this configuration can further improve the productivity (assemblability) of the lens driving device 101.

As illustrated in FIG. 13, in a plan view along the optical axis direction, the first wire SA1 may be arranged along one (the first side SD1) of two sides (adjacent sides) substantially perpendicular to each other, and the second wire SA2 may be arranged along the other (the second side SD2) of the two sides. At least a portion of the second base-side metal member 5F2 and the third base-side metal member 5F3 may face each other in the optical axis direction. In other words, at least a portion of the second base-side metal member 5F2 and the third base-side metal member 5F3 may overlap in the optical axis direction. In FIG. 13, for easy understanding of the description, the portion of the base-side metal member 5F overlapping in the optical axis direction is indicated by dot patterns.

This configuration provides an effect that the first driver DM1 can be downsized and the lens driving device 101 can be downsized as compared with a configuration in which the second base-side metal member 5F2 and the third base-side metal member 5F3 do not overlap each other in the optical axis direction.

As illustrated in FIG. 2, the shape memory alloy wire SA may include the third wire SA3 and the fourth wire SA4, and the base member 3 may be provided with the fifth base-side metal member 5F5 and the sixth base-side metal member 5F6 arranged apart from each other in the first direction (the right-left direction, the Y-axis direction), and a seventh base-side metal member 5F7 and an eighth base-side metal member 5F8 arranged apart from each other in the second direction (the front-rear direction, the X-axis direction). One end of the third wire SA3 may be fixed to the fifth base-side metal member 5F5, the other end of the third wire SA3 may be fixed to the sixth base-side metal member 5F6, and an intermediate portion of the third wire SA3 positioned between the one end and the other end of the third wire SA3 may be fixed to the third lens-side metal member 5M3 as the third central fixing portion CF3 provided on the lens holding member 2. One end of the fourth wire SA4 may be fixed to the seventh base-side metal member 5F7, the other end of the fourth wire SA4 may be fixed to the eighth base-side metal member 5F8, and an intermediate portion of the fourth wire SA4 positioned between the one end and the other end of the fourth wire SA4 may be fixed to the fourth lens-side metal member 5M4 as the fourth central fixing portion CF4 provided on the lens holding member 2. In this case, the first wire SA1 and the third wire SA3 may be provided to be separated from each other (to face each other) with the lens holding member 2 (the cylindrical portion 2C) interposed therebetween in the second direction (the front-rear direction, the X-axis direction), and the second wire SA2 and the fourth wire SA4 may be provided to be separated from each other (to face each other) with the lens holding member 2 (the cylindrical portion 2C) interposed therebetween in the first direction (the right-left direction, the Y-axis direction). The first base-side metal member 5F1, the third base-side metal member 5F3, the fifth base-side metal member 5F5, and the seventh base-side metal member 5F7 may have the same shape and the same size; the second base-side metal member 5F2, the fourth base-side metal member 5F4, the sixth base-side metal member 5F6, and the eighth base-side metal member 5F8 may have the same shape and the same size; and the first lens-side metal member 5M1, the second lens-side metal member 5M2, the third lens-side metal member 5M3, and the fourth lens-side metal member 5M4 may have the same shape and the same size. This configuration provides an effect that the number of components can be further reduced by sharing the components.

The lens driving device 101 may include the plate spring 6 that connects the lens holding member 2 and the base member 3 as illustrated in FIG. 2. This configuration provides an effect that the lens holding member 2 can be centered in the XY plane with respect to the base member 3 by the plate spring 6.

The lens holding member 2 may be provided with the lens-side magnetic member MP as illustrated in the top diagram of FIG. 3, and the base member 3 may be provided with the magnet 4 as illustrated in the top diagram of FIG. 6. The lens holding member 2 and the base member 3 may be configured to maintain a predetermined positional relationship with each other by an attraction force acting between the magnet 4 and the lens-side magnetic member MP. The predetermined positional relationship is, for example, a positional relationship between the lens holding member 2 and the base member 3 in the lens driving device 101 in an initial state, and corresponds to a positional relationship between the lens holding member 2 and the base member 3 in the lens driving device 101 in the neutral state in each of the X-axis direction and the Y-axis direction. The initial state of the lens driving device 101 is, for example, a state of the lens driving device 101 when no current is supplied to the shape memory alloy wire SA and the shape memory alloy wire SB. In the illustrated example, the lens holding member 2 is configured to be centered with respect to the base member 3 by the attraction force acting between the first magnet 41 and the first lens-side magnetic member MP1 (the fourth exposed portion 20DQ of the fourth lens-side embedded member 20D) and the attraction force acting between the second magnet 42 and the second lens-side magnetic member MP2 (the eighth exposed portion 20HQ of the eighth lens-side embedded member 20H).

This configuration provides an effect that the lens holding member 2 can be centered with respect to the base member 3. In the initial state, the lens driving device 101 is configured in such a manner that the contact portion 2S (see FIG. 4) of the lens holding member 2 and the contact portion 3S (see FIG. 5) of the base member 3 are in contact with each other. On the other hand, in the neutral state, the lens driving device 101 is configured in such a manner that the lens holding member 2 and the base member 3 do not come into contact with each other. This configuration also provides an effect of preventing the lens holding member 2 and the base member 3 from being separated from each other in the optical axis direction when the lens driving device 101 is in the initial state.

The magnetic member 10 may be fixed to the support member 8 as illustrated in FIG. 1, and the magnet 4 may be provided on the base member 3 as illustrated in the top diagram of FIG. 6. The base member 3 and the support member 8 may be configured to maintain a predetermined positional relationship with each other by an attractive force acting between the magnet 4 and the magnetic member 10.

This configuration provides an effect of preventing the base member 3 and the support member 8 from being separated from each other in the optical axis direction. Therefore, this configuration can maintain a contact state between the guide portion GD and the guided portion GE.

The preferred embodiments of the present invention have been described in detail above. However, the present invention is not limited to the above-described embodiment. Various modifications and substitutions may be applied to the above-described embodiment and the embodiment described below without departing from the scope of the present invention. The features described with reference to the above-described embodiment and the embodiment described below may be appropriately combined as long as there is no technical contradiction.

For example, in the above-described embodiment, the metal member 5 is fixed to each member (each of the lens holding member 2, the base member 3, and the support member 8) with an adhesive or the like, but the metal member 5 may be embedded in each member, or may be a conductive pattern formed on the surface of each member.

What is claimed is:

1. A lens driving device, comprising:
a base member;
a lens holding member configured to hold a lens body; and
a driver configured to include a shape memory alloy wire configured to move the lens holding member along an optical axis direction with respect to the base member, wherein
the shape memory alloy wire includes a first wire,
the base member is provided with a first base-side metal member and a second base-side metal member which are arranged to be separated from each other in a first direction intersecting with the optical axis direction,
the first wire has one end portion fixed to the first base-side metal member and an other end portion fixed to the second base-side metal member, and an intermediate portion of the first wire positioned between the one end portion and the other end portion of the first wire is fixed to a first central fixing portion provided on the lens holding member,
the first central fixing portion is arranged between the first base-side metal member and the second base-side metal member in a plan view along the optical axis direction, and
the intermediate portion of the first wire is arranged at a position different from each of the one end portion and the other end portion of the first wire in the optical axis direction.

2. The lens driving device according to claim 1, wherein
the first central fixing portion is configured by a first lens-side metal member formed of a metal.

3. The lens driving device according to claim 2, wherein
the first base-side metal member, the second base-side metal member, and the first lens-side metal member are configured by respective metal plates having respective plate-shaped base portions, and
plate surfaces of the base portions respectively constituting the first base-side metal member, the second base-side metal member, and the first lens-side metal member are substantially parallel to each other.

4. The lens driving device according to claim 3, wherein
the intermediate portion of the first wire is positioned at a position lower than each of the one end portion and the other end portion of the first wire in the optical axis direction,
the shape memory alloy wire includes a second wire,
the base member is provided with a third base-side metal member and a fourth base-side metal member which are arranged to be separated from each other in a second direction which intersects the optical axis direction and is perpendicular to the first direction,
the second wire has one end portion fixed to the third base-side metal member and an other end portion fixed to the fourth base-side metal member,
an intermediate portion of the second wire positioned between the one end portion and the other end portion of the second wire is fixed to a second lens-side metal member as a second central fixing portion provided on the lens holding member,
the second lens-side metal member is arranged between the third base-side metal member and the fourth base-side metal member in a plan view along the optical axis direction, and
the intermediate portion of the second wire is arranged at a position higher than each of the one end portion and the other end portion of the second wire in the optical axis direction.

5. The lens driving device according to claim 4, wherein
the third base-side metal member, the fourth base-side metal member, and the second lens-side metal member are configured by respective metal plates having respective plate-shaped base portions, and
plate surfaces of the base portions respectively constituting the third base-side metal member, the fourth base-side metal member, and the second lens-side metal member are substantially parallel to each other.

6. The lens driving device according to claim 5, wherein
the first base-side metal member and the third base-side metal member have a same shape and a same size,
the second base-side metal member and the fourth base-side metal member have a same shape and a same size, and
the first lens-side metal member and the second lens-side metal member have a same shape and a same size.

7. The lens holder driving device according to claim 5, wherein
plate surfaces of the base portions respectively constituting the first base-side metal member, the second base-side metal member, the third base-side metal member, the fourth base-side metal member, the first lens-side metal member, and the second lens-side metal member are substantially perpendicular to the optical axis direction.

8. The lens driving device according to claim 7, wherein
in a plan view along the optical axis direction, the first wire is arranged along one of two sides substantially perpendicular to each other, and the second wire is arranged along the other of the two sides, and
the second base-side metal member and the third base-side metal member are at least partially facing each other in the optical axis direction.

9. The lens holder driving device according to claim 4, wherein
the shape memory alloy wire includes a third wire and a fourth wire,
the base member is provided with a fifth base-side metal member and a sixth base-side metal member which are arranged to be separated from each other in the first direction, and a seventh base-side metal member and an eighth base-side metal member which are arranged to be separated from each other in the second direction,
the third wire has one end portion fixed to the fifth base-side metal member and an other end portion fixed to the sixth base-side metal member,
an intermediate portion of the third wire positioned between the one end portion and the other end portion of the third wire is fixed to a third lens-side metal member as a third central fixing portion provided on the lens holding member,
the fourth wire has one end portion fixed to the seventh base-side metal member and an other end portion fixed to the eighth base-side metal member,
an intermediate portion of the fourth wire positioned between the one end portion and the other end portion of the fourth wire is fixed to a fourth lens-side metal member as a fourth central fixing portion provided on the lens holding member, and
the first wire and the third wire are provided to be separated from each other with the lens holding member interposed therebetween in the second direction,
the second wire and the fourth wire are provided to be separated from each other, with the lens holding member interposed therebetween in the first direction,
the first base-side metal member, the third base-side metal member, the fifth base-side metal member, and the seventh base-side metal member have a same shape and a same size,
the second base-side metal member, the fourth base-side metal member, the sixth base-side metal member, and the eighth base-side metal member have a same shape and a same size, and
the first base-side metal member, the second base-side metal member, the third base-side metal member, and the fourth base-side metal member have a same shape and a same size.

10. The lens driving device according to claim 1, further comprising:
a plate spring that connects the lens holding member and the base member.

11. The lens driving device according to claim 1, wherein
the lens holding member is provided with a lens-side magnetic member,
the base member is provided with a magnet, and
the lens holding member and the base member are configured to maintain a predetermined positional relationship with each other by an attraction force acting between the magnet and the lens-side magnetic member.

12. A camera module, comprising:
the lens driving device according to claim 1;
the lens body fixed to the lens holding member; and
an image sensor facing the lens body.
